(19) United States
(12) Patent Application Publication
(10) Pub. No.: US 2018/0077991 A1
(43) Pub. Date: Mar. 22, 2018

(54) Shock Mitigating Materials and Methods Utilizing Sutures

(71) Applicant: Mississippi State University, Mississippi State, MS (US)

(72) Inventor: Mark F. Horstemeyer, Starkville, MS (US)

(73) Assignee: Mississippi State University, Mississippi State, MS (US)

(21) Appl. No.: 15/670,879

(22) Filed: Aug. 7, 2017

Related U.S. Application Data
(63) Continuation-in-part of application No. 13/469,172, filed on May 11, 2012, now Pat. No. 9,726,249.
Application No. 13/469,172 is a continuation-in-part of application No. 14/694,715, filed on Apr. 23, 2015, now Pat. No. 9,820,522.

(51) Int. Cl. A42B 3/12; A42B 3/06

(52) U.S. Cl. CPC A42B 3/128; B32B 5/18; A42B 3/063

(57) ABSTRACT

Various embodiments of a spiral shaped element and wavy suture are disclosed for use in a shock mitigating material to dissipate the energy associated with the impact of an object. The shock mitigating material can be used in helmets, bumpers, bulletproof vests, mats, pads, foot gear, military armor, and other applications. One embodiment, among others, is a shock mitigating material having spiral shaped elements, each having a circular cross section and each being tapered from a large outside end to a small inside end but also having a suture or sutures that can induce shear waves to mitigate the shock pressure and impulse. Another embodiment is a shock mitigating material having sutures (wavy gaps or wavy materials). In this embodiment when the material is impacted, the wavy gap or material will induce a mechanism in shear to dissipate the impact energy and action.

### CLAIM OF PRIORITY

This application is a continuation-in-part of U.S. patent application Ser. No. 13/469,172, filed May 11, 2012, which claims priority to and the benefit of U.S. Provisional Patent Application No. 61/485,847, filed May 13, 2011, the entirety of both of which is incorporated herein by reference.

This application is a continuation-in-part of U.S. patent application Ser. No. 14/694,715, filed Apr. 23, 2015, which claims priority to and the benefit of U.S. Provisional Patent Application No. 61/983,133, filed Apr. 23, 2014, the entirely of both of which is incorporated herein by reference.

### STATEMENT OF GOVERNMENT SUPPORT

This invention was made with Government support under DE-EE0002323 awarded by the U.S. Department of Energy. The Government has certain rights in the invention.

### FIELD OF THE INVENTION

The present invention generally relates to shock mitigating materials and, more particularly, to materials that can be used in helmets, bumpers, bullet proof vests, military armor, pads, mats, footwear or gear, and other applications to dissipate energy and action associated with an object impact.

### BACKGROUND OF THE INVENTION

American football can be a very dangerous sport for its players. Players continue to get bigger and stronger and the speed of play continues to increase. Players commonly suffer injures. In fact, currently the average career of a player in the National Football League (NFL) is just over four (4) years. Furthermore, head injuries are common. Current helmet designs are not adequately protecting the players. There is a need for improved football helmet designs that better protect players. However, impacts that induce injuries including brain injuries are not only related to sporting events like football, baseball, and hockey, but such impacts can occur from motorcycle, bicycle, and vehicle crashes and military strikes, for example.

### SUMMARY OF THE INVENTION

The present invention provides descriptions of various embodiments of a cantilevered spiral shaped element and wavy structures that can be used in a manufactured (man-made) shock mitigating material to dissipate the energy associated with the impact of an object, so that energy moving in the direction or transverse to the direction or any angle in between of the object impact is attenuated. The shock mitigating material can be used in various articles of manufacture including for example, but not limited to, helmets of virtually any kind, bumpers, bullet proof vests, military armor, body pads, floor or other types of mats, footwear, and many other applications. The shock mitigating material can be of any relevant size and can be of any shape, such as curved and/or planar, for example.

One embodiment of the present invention, among others, is shock mitigating material having one or more spiral shaped elements contained therein, each having a circular, polygonal, rectangular, triangular, or any combination of these as a cross section, and each being tapered from a large end to a small inside end, or vice versa. Furthermore, one of the ends is fixed, or mounted, while the other end is free, or unmounted, so that when the material is impacted by an object, the impact energy is converted into shear waves by the spiral elements as the free ends of the spiral elements vibrate. This dissipates impact energy and action (energy multiplied by time).

Another embodiment, among others, is a shock mitigating material having one or more sutures (wavy gaps or wavy materials). The sides of the wavy gap or wavy material can be periodic (e.g., sinusoidal, saw tooth, circular, etc., or non-periodic (e.g., random, etc.). In this embodiment, when the material is impacted the suture will induce a mechanism in shear to dissipate the impact energy and action.

Another embodiment is an article of manufacture having a manufactured, shock mitigating, material layer that dissipates impact energy when the article is physically impacted by an object. The material layer comprises first and second sections and a suture junction where the first and second sections meet. The suture junction has first and second edges associated respectively with the first and second sections. The first and second edges generally exhibit periodic waveforms. Each of the first and second edges are movable relative to each other so that the first and second edges are capable of transforming a substantial part of a longitudinal mechanical shock wave imposed upon the first and second edges into shear waves within the material layer when the article of manufacture is impacted by the object in order to dissipate the impact energy and action. In this embodiment, the first and second sections can be made of the same or different materials. Each can be made of nylon, polycarbonate, polypropylene, and/or polymer (e.g., Acrylonitrile-Butadiene-Styrene (ABS)), etc.

Another embodiment, among others, is an article of manufacture having a manufactured, shock mitigating, material layer designed to dissipate impact energy when the article is physically impacted by an object. The material layer has first and second sections, each of the first and second sections having a top surface, a bottom surface, and a periphery of edges. First and second edges associated respectively with the first and second sections exhibit substantially parallel waveforms. There also can be a third section between the first and second edges of the first and second sections. The third section exhibits a wavy configuration. Each of the first and second edges are movable relative to each other so that the first and second edges are capable of transforming a substantial part of a longitudinal mechanical shock wave imposed upon the first and second edges into shear waves within the material layer when the article of manufacture is impacted by an object in order to dissipate the impact energy and action. In terms of materials, the first and second sections are each made of a material selected from a group consisting of nylon, polycarbonate, polypropylene, and/or polymer (e.g., Acrylonitrile-Butadiene-Styrene (ABS)). The third section is made of a material selected from a group consisting of a polymer and a rubber.

Another embodiment, among others, is an article of manufacture that comprises a plurality of layers that exhibit waviness in different directions and/or different planes (perpendicular or transverse) to more effectively dissipate impact energy by converting same into shear waves when the article is impacted.

Other embodiments, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the geometric effects of the present invention. Moreover, in the drawings, like reference numerals designate corresponding parts throughout the several views. FIGS. 1 through 10 relate to a first study and FIGS. 11 through 21 relate to a second study concerning the present invention.

FIG. 1(a) is a schematic representation of the four finite element models used in the analysis to demonstrate the energy dissipating properties of spiral shaped elements.

FIG. 1(b) shows a suture within a structure in which the finite element model illustrates the wave dispersion effects from the suture.

FIG. 2 is a graph of ramped, pressure load history applied to a fixed end of each of the models of FIG. 1(a).

FIGS. 3(a) and 3(b) show displacement (a) contour and (b) wave propagation plots, respectively, of each of the models of FIG. 1(a).

FIGS. 4(a) and 4(b) show pressure (a) contour and (b) wave propagation plots, respectively, of each of the models of FIG. 1(a).

FIGS. 5(a) and 5(b) show Von Mises stress (a) contour and (b) wave propagation plots, respectively, of each of the models of FIG. 1(a).

FIGS. 6(a) and 6(b) show normalized free-end (a) pressure and (b) displacement response, respectively, of a cylinder, tapered cylinder, spiral, and tapered spiral. The lower abscissa specifies the time at which the longitudinal wave first reaches the free end. The reflected longitudinal wave arrives back at the fixed end and so on. Similarly, the upper abscissa corresponds to the time at which the shear wave reaches the free end.

FIGS. 7(a) and 7(b) show normalized (a) impulse and (b) displacement, respectively, at the free end of each model of FIGS. 6(a) and 6(b). Impulse is found by multiplication of the free-end pressure history by the respective free-end area of each geometry followed by integration of the resulting force history (where negative values are neglected). Free-end displacement is taken as the area under the free-end displacement history curve. The free-end impulse and displacement values of the cylinder are used to normalize the results.

FIG. 8 is a graph showing a normalized free-end transverse displacement response for the models of FIGS. 6(a) and 6(b).

FIG. 9 shows finite element simulation results of the pressure wave as it traversed down different blocks of material with the (a) straight line, (b) single wave embedded in the block of material with a straight edge, (c) single wave embedded in a block of material with an out-of-phase wavy structure, and (d) single wave embedded in a block of material with an in-phase wavy structure.

FIG. 10 shows the free-end transverse impulse from the different wave configurations embedded within the material.

FIG. 11 shows suture lines in biological materials: (a) shows a suture line shown at the tip of woodpecker beaks (keratin); (b) shows a cranial suture in a bison skull (bone); (c) shows a wavy line in a surface of an ammonoid fossil (calcium carbonate); and (d) shows a suture at a box turtle (bone).

FIG. 12(a) shows an idealized two-dimensional bar with a suture interface of gap thickness of b. The dimension of the bar is L=1000 mm, t=15 mm, and b=2 mm. The pressure initiated on the left side of the bar.

FIG. 12(b) shows a schematic of an idealized bar with a flat interface.

FIG. 12(c) shows, following an initial impact pressure applied in Region 1, the pressure data were recorded at the eleven regions indicated by the red regions in the bar. Then, the peak pressures were connected by the red dotted line in the graph. As the pressure wave propagated in the bar, the peak pressure decreased.

FIG. 13 shows seven variables influencing the stress wave mitigation: (a) shows suture waviness (ratio of suture height to suture period); (b) shows Rsuture, the ratio of the suture height to the bar thickness; (c) shows thickness of the gap; (d) shows material properties of the elastic wall; (e) shows type of boundary; (f) shows amplitude of the impact; and (g) shows impact duration. The default values are in bold font.

FIG. 14 shows a comparison of pressure recorded along the sutured bar and unsutured bar. Each point represents the peak pressure at the eleven regions. The initial impact was 1 MPa, and the pressure when stress waves reached to the end was 0.47 MPa for the unsutured bar and 0.1 MPa for the sutured bar.

FIG. 15 shows reflections of compressive incidence waves striking a curved boundary. The incident longitudinal wave with an angle of θ_{L0} reflected to a longitudinal wave with an angle of θ_{L} and a shear wave with an angle of θ_{S}.

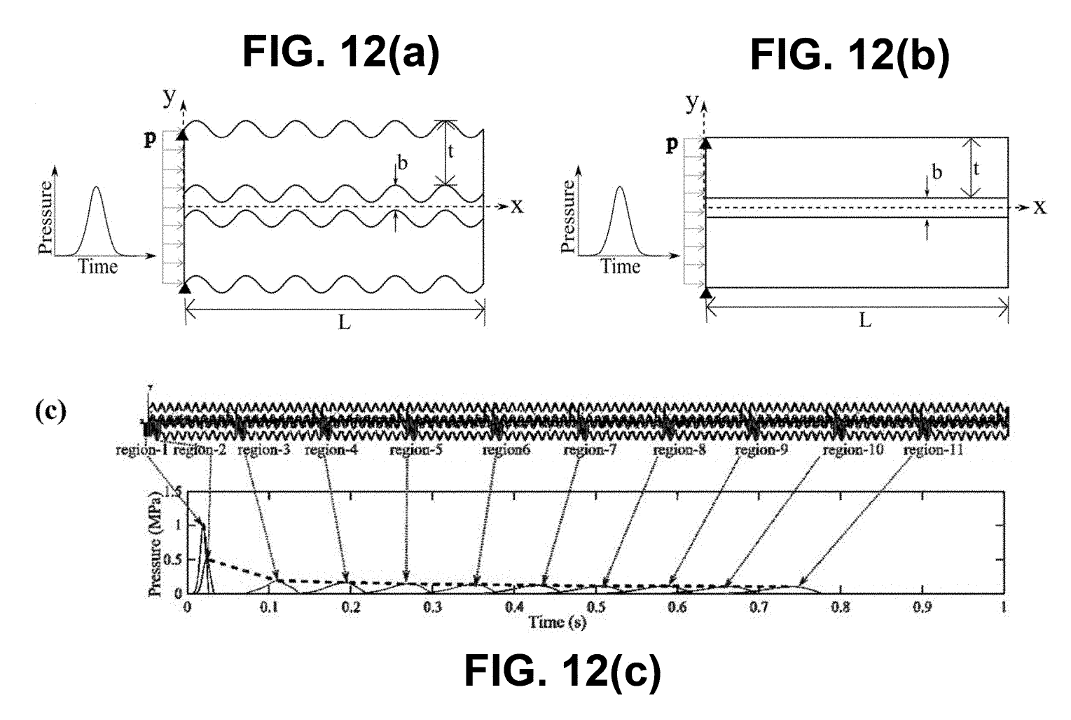

FIG. 16 shows stress waves shown as a function of time in the eleven regions along the sutured bar illustrating the stress components of (a) S11, (b) S22, (c) S12, and along the unsutured bar also illustrating (d) S11, (e) S22, and (f) S12. The stress waves were plotted until the wave reached the end of the bar. For the sutured bar, the stress wave reached the end at 0.78 ms, and for the unsutured bar, the stress wave reach the end at 0.55 ms.

FIG. 17 shows strain in the eleven regions along the sutured bar for the strain components of (a) LE11, (b) LE22, (c) LE12 and along the unsutured bar for the stress components of (d) LE11, (e) LE22, and (f) LE12.

FIG. 18 shows a maximum strain energy density associated with different displacements in the x, y, and z directions for the sutured and unsutured bar in Region 2 (indicated in FIG. 12(c)) near the initial impact location. The total strain energy is greater for the sutured bar than that of the unsutured bar because the strain energy to yy and xy direction is much greater at the sutured bar.

FIG. 19 shows a strain energy occurring at the gap of the sutured bar (black) compared to the unsutured bar (red).

FIG. 20(a) shows pressure wave decay as pressure waves traveled from the load applied region to the free end at the idealized bar with a suture interface at the first of seven variables (waviness). Points are 100 mm apart in the pressure decay graphs.

FIG. 20(b) shows compressional stress when the stress wave reaches to the free end, maximum shear stress and maximum flexural stress while pressure wave traveling at the first of seven variables (waviness).

FIG. 20(c) shows pressure wave decay as pressure waves traveled from the load applied region to the free end at the idealized bar with a suture interface at the second of seven variables (Rₛᵤₜᵤᵣₑ which is the ratio of the suture height to the bar thickness). Points are 100 mm apart in the pressure decay graphs.

FIG. 20(d) shows compressional stress when the stress wave reaches to the free end, maximum shear stress and maximum flexural stress while pressure wave traveling at the second of seven variables (Rₛᵤₜᵤᵣₑ which is the ratio of the suture height to the bar thickness).

FIG. 20(e) shows pressure wave decay as pressure waves traveled from the load applied region to the free end at the idealized bar with a suture interface at the third of seven variables (thickness of the gap). Points are 100 mm apart in the pressure decay graphs.

FIG. 20(f) shows compressional stress when the stress wave reaches to the free end, maximum shear stress and maximum flexural stress while pressure wave traveling at the third of seven variables (thickness of the gap).

FIG. 20(g) shows pressure wave decay as pressure waves traveled from the load applied region to the free end at the idealized bar with a suture interface at the fourth of seven variables (material properties). Points are 100 mm apart in the pressure decay graphs.

FIG. 20(h) shows compressional stress when the stress wave reaches to the free end, maximum shear stress and maximum flexural stress while pressure wave traveling at the fourth of seven variables (material properties).

FIG. 20(i) shows pressure wave decay as pressure waves traveled from the load applied region to the free end at the idealized bar with a suture interface at the fifth of seven variables (type of the wall boundary: in-phase suture, out-of-phase suture, only center suture, and only outside suture). Points are 100 mm apart in the pressure decay graphs.

FIG. 20(j) shows compressional stress when the stress wave reaches to the free end, maximum shear stress and maximum flexural stress while pressure wave traveling at the fifth of seven variables (type of the wall boundary: in-phase, out-of-phase, only center, and only outside).

FIG. 20(k) shows pressure wave decay as pressure waves traveled from the load applied region to the free end at the idealized bar with a suture interface at the fifth of seven variables (type of the wall boundary: infinite boundary with no suture and infinite boundary with center suture). Each point is 10 mm apart in the pressure decay graphs.

FIG. 20(l) shows compressional stress when the stress wave reaches to the free end, maximum shear stress and maximum flexural stress while pressure wave traveling at the fifth of seven variables (type of the wall boundary: infinite boundary with no suture and infinite boundary with center suture).

FIG. 20(m) shows pressure wave decay as pressure waves traveled from the load applied region to the free end at the idealized bar with a suture interface at the sixth of seven variables (amplitude of the loading). Each point is 10 mm apart in the pressure decay graphs.

FIG. 20(n) shows compressional stress when the stress wave reaches to the free end, maximum shear stress and maximum flexural stress while pressure wave traveling at the sixth of seven variables (amplitude of the loading).

FIG. 20(o) shows pressure wave decay as pressure waves traveled from the load applied region to the free end at the idealized bar with a suture interface at the seventh of seven variables (impact duration). Each point is 10 mm apart in the pressure decay graphs.

FIG. 20(p) shows compressional stress when the stress wave reaches to the free end, maximum shear stress and maximum flexural stress while pressure wave traveling at the seventh of seven variables (impact duration).

FIG. 21(a) shows the data points of the damping quotient with its associated curve fit at the first of seven variables (waviness).

FIG. 21(b) shows the data points of the normalized phase velocity and the curve fitting at the first of seven variables (waviness).

FIG. 21(c) shows the data points of the damping quotient with its associated curve fit at the second of seven variables (Rₛᵤₜᵤᵣₑ which is the ratio of the suture height to the bar thickness).

FIG. 21(d) shows the data points of the normalized phase velocity and the curve fitting at the second of seven variables (Rₛᵤₜᵤᵣₑ which is the ratio of the suture height to the bar thickness).

FIG. 21(e) shows the data points of the damping quotient with its associated curve fit at the third of seven variables (thickness of the gap).

FIG. 21(f) shows the data points of the normalized phase velocity and the curve fitting at the third of seven variables (thickness of the gap).

FIG. 21(g) shows the data points of the damping quotient with its associated curve fit at the fourth of seven variables (material properties).

FIG. 21(h) shows the data points of the normalized phase velocity and the curve fitting at the fourth of seven variables (material properties).

FIG. 21(i) shows the data points of the damping quotient with its associated curve fit at the fifth of seven variables (type of wall boundaries: in-phase, out-of-phase, only center, and only outside).

FIG. 21(j) shows the data points of the normalized phase velocity and the curve fitting at the fifth of seven variables (type of wall boundaries: in-phase, out-of-phase, only center, and only outside).

FIG. 21(k) shows the data points of the damping quotient with its associated curve fit at the fifth of seven variables (type of wall boundaries: infinite boundary with no suture and infinite boundary with center suture).

FIG. 21(l) shows the data points of the normalized phase velocity and the curve fitting at the fifth of seven variables (type of wall boundaries: infinite boundary with no suture and infinite boundary with center suture).

FIG. 21(m) shows the data points of the damping quotient with its associated curve fit at the sixth of seven variables (loading amplitude).

FIG. 21(n) shows the data points of the normalized phase velocity and the curve fitting at the sixth of seven variables (loading amplitude).

FIG. 21(o) shows the data points of the damping quotient with its associated curve fit at the seventh of seven variables (impact duration).

FIG. 21(p) shows the data points of the normalized phase velocity and the curve fitting at the seventh of seven variables (impact duration).

FIG. 22 is a cross-sectional view of an embodiment of a football helmet having a plurality of material layers including a shock mitigating material layer having spiral shaped elements.

FIG. 23(a) is a partial enlarged view of a first embodiment of the plurality of layers of FIG. 22.

FIG. 23(b) is a partial enlarged view of a second embodiment of the plurality of layers of FIG. 22.

FIG. 24 is a partial enlarged view of a third embodiment of the plurality of layers for the helmet of FIG. 22.

FIG. 25 is a perspective view of a first embodiment of the spiral shaped elements of the shock mitigating material layer of FIG. 22 wherein the spiral shaped element is in a planar configuration.

FIG. 26 is a perspective view of a second alternative embodiment of the spiral shaped elements of the shock mitigating material layer of FIG. 22 wherein the spiral shaped element is in a helix configuration.

FIG. 27(a) is a perspective view of an embodiment of a material layer for a football helmet wherein the material layer has a plurality of sutures.

FIG. 27(b) is a perspective view of the embodiment of FIG. 27(a) but with sections separated in order to illustrate the sutures.

FIG. 27(c) is a rear view of the embodiment of FIG. 27(a).

FIG. 27(d) is a rear view of the embodiment of FIG. 27(a) but with the sections separated in order to illustrate the sutures.

### DETAILED DESCRIPTION OF THE PREFERRED EMBODIMENTS

The physics of stress waves, and all other wave types, are governed by three fundamental, conservation laws: conservation of mass, momentum, and energy. Neglecting surface waves, there are two main types of waves that propagate through elastic, isotropic solids: longitudinal waves and shear waves. Longitudinal (also called dilatational, pressure, primary, or P-waves) propagate with a characteristic wave speed and represent a volumetric change. Their motion is parallel to the direction of propagation of the wave. Shear waves (also called secondary, S-, or distortional waves) represent no volume change, and propagate at a slower wave speed with respect to longitudinal waves. Their motion is normal to the direction of propagation. See, for example, Davis J. L., “Wave Propagation in Solids and Fluids,” New York, N.Y.: Spring-Verlag Inc., 1988; Zukas J. A., Nicholas T, Swift H. F., Greszczuk L B, Curran D. R., “Impact Dynamics,” Malabar, F. L., Krieger Publishing Co., 1992; and Achenbach J. D., “Wave propagation in elastic solids,” North-Holland, 1993, all of the foregoing publications of which are incorporated herein by reference in their entirety.

When either a longitudinal or shear wave impinges on a boundary, new waves are generated due to the reflective nature of waves. In a body with finite dimensions, these waves bounce back and forth between the bounding surfaces and interact with one another. These interactions can lead to wave amplification, cancellation, and other wave distortions. In the present invention described herein, both the spiral geometry and suture(s) introduce deleterious shear waves that disperse, attenuate, and dissipate the input pressure.

When the cross-sectional area of a cylindrical bar is reduced, a geometric impedance difference arises despite the intrinsic impedance of the material remaining unaltered.

When a compressive elastic wave produced by a dynamic load or impact reaches the free end (or unattached or unmounted end) of the bar, it reflects back from that surface as a tensile wave. This reflected tensile wave can have detrimental effects on the medium through which it travels.

Impulse is defined as the integral of a force with respect to time. The impulse is equal to the change in momentum of the body. It is possible for a very brief force to produce a larger impulse than a force acting over a much larger time period if that force is sufficiently large. Therefore, it is important to consider these transient forces. A fast-acting force can often be more detrimental to a structure than one that is more dispersed with respect to time.

A first experimental study and a second experimental study will now be described hereafter.

A. First Experimental Study—Shock Mitigating Materials

Geometry plays a critical role in the response of a structure to a dynamic load. The four spiral geometries included in this first study concerning this invention disclosure comprise a cylindrical bar, a tapered cylindrical bar, a spiral with a cylindrical cross-section, and a tapered spiral with a cylindrical cross-section. The cylindrical bar serves as a ‘base-line’ case. By comparing the response of the tapered cylinder to that of the uniform cylinder, we gain insight into how reducing the cross-sectional area influences the transient response of the structure. Similarly, comparison of the spiral geometry to the uniform cylinder leads to an understanding of the effects of increasing curvature on the wave propagation. Finally, analysis of the tapered spiral allows us to understand the coupled influence of increasing curvature and decreasing cross-sectional area on wave propagation and reflection.

The suture is also a geometric effect that plays a critical role in structures under dynamic loads. The suture is compared to a baseline embedded straight line showing the much greater dissipation by way of lower pressures and lower impulses.

With the exception of the simple cylinder, obtaining exact solutions for these geometries is unpractical, if not impossible. Furthermore, the main goal of the analysis behind the present invention was to provide more of a qualitative understanding of how the transients are affected by only geometric differences. For these reasons, a purely computational approach employing the finite element (FE) method was chosen to study the wave propagation and reflection characteristics of these bodies. The FE method is the most efficient technique to perform these types of studies and has become a widely accepted analysis tool. See, for example, Demma A, Cawley P, Lowe M, Pavlakovic B., “The effect of bends on the propagation of guided waves in pipes,” Journal of Pressure Vessel Technology, Transactions of the ASME 2005; 127:328; Gavric L., “Computation of Propagative Waves in Free Rail Using a Finite Element Technique,” Journal of Sound and Vibration 1995; 185:531; Treysséde F., “Elastic Waves in Helical Waveguides,” Wave Motion 2008; 45:457; Mace B R, Duhamel D, Brennan M J, Hinke L, “Finite Element Prediction of Wave Motion in Structural Waveguides,” Journal of the Acoustical Society of America 2005; 117:2835; and “ABAQUS v6.10 User Documentation,” Providence, R.I.: Dassault Systemes Simulia Corp., 2010, all of the foregoing of which are incorporated herein by reference.

1. Methodology

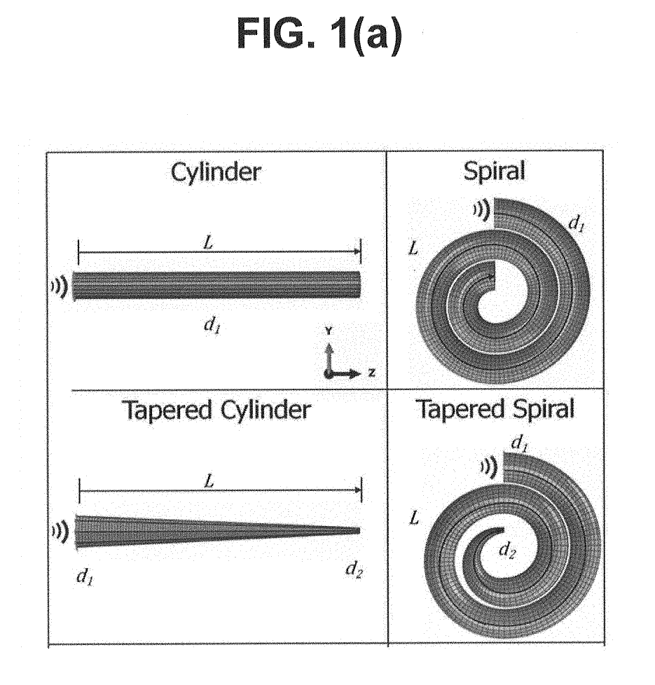

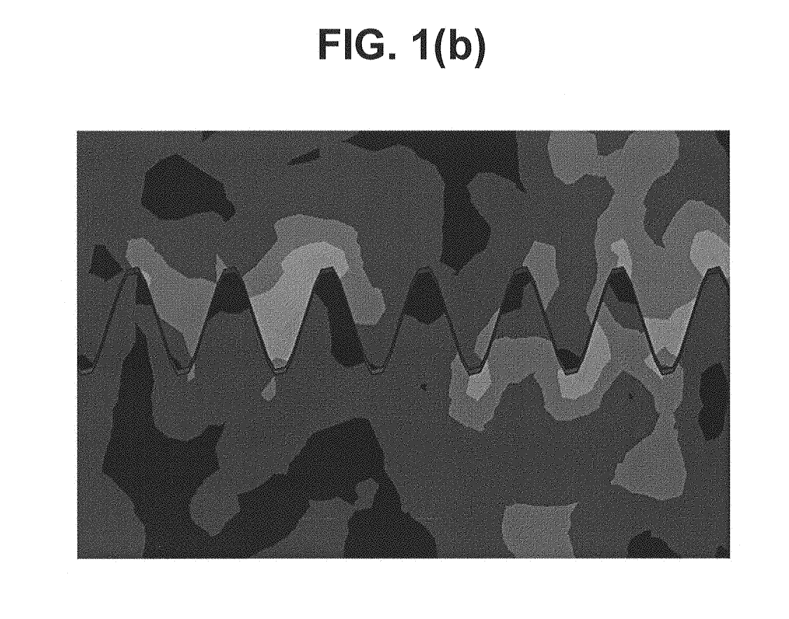

FIG. 1(a) depicts the four geometries that were studied along with the load and boundary conditions that were prescribed. The length and cross-sectional dimensions of each model were kept consistent. The actual dimensions used in the finite element analysis are provided in Table 1.

The ratio of total length to cross-sectional diameter was also maintained among the four geometries, i.e., L/d₁=10. The ratio of the large and small-end diameters was also consistent; d₁/d₂=2 for the tapered geometries.

TABLE 1
Actual dimensions of each geometry used in finite element analysis.

| | | | | Fixed- | |
|---|---|---|---|---|---|
| | | Fixed- | Free-end | end | |
| | Total | end | Diameter, | Area, | Free-end |
| | Length, L | Diameter, | d₂ | A₁ | Area, A₂ |
| Geometry | (×10⁻¹ m) | d₁(×10⁻² m) | (×10⁻² m) | (×10⁻³ m²) | (×10⁻³ m²) |
| Cylinder | 7.04 | 7.04 | 7.04 | 3.89 | 3.89 |
| Tapered | 7.04 | 7.04 | 3.52 | 3.89 | 0.97 |
| Cylinder | | | | | |
| Spiral | 7.04 | 7.04 | 7.04 | 3.89 | 3.89 |
| Tapered | 7.04 | 7.04 | 3.52 | 3.89 | 0.97 |
| Spiral | | | | | |

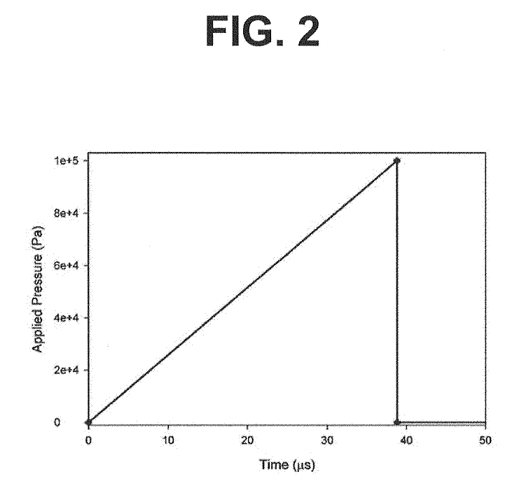

The finite element program ABAQUS/Explicit v6.10 [10] was used as the numerical model in this study for all simulations. It is anticipated that any finite element code would give similar results to all of the solutions generated here. Linear elastic material properties typical of steel were used; i.e. mass density, Poisson's ratio, ν=0.3, and Young's modulus, E=207 GPa. All geometries were meshed with 3-dimensional, 8-noded, continuum, linear, brick elements with reduced integration and hourglass control (C3D8R). A ramped, compressive, pressure pulse was applied to the end of each bar. The peak amplitude and duration were set as 1×10⁵ Pa and 38.8 μs, respectively. The prescribed load history is shown in FIG. 2. The nodes along the outer perimeter of the load-end were pinned (u₁=ᵤ₂=ᵤ₃=0) for each case. No additional constraints were prescribed. The resulting stress wave was allowed to propagate through the structure for 800 μs prior to terminating the calculation.

Post-processing of data was performed using ABAQUS/CAE v6.10 [10]. Wave propagation plots were generated by defining a path through each model that extended from the cross-sectional center of the fixed end (or attached end or mounted end) to the cross-sectional center of the free end (or unattached end or unmounted end). Pressure and displacement response histories at the free-ends were generated by averaging the respective output of each node lying on the cross-section of the free end.

FIG. 1(b) shows the wave dispersion of the pressure once a wave was initiated at the left end of the block. There is a gap between the upper and lower material in a wave form.

2. Results

The speed at which a longitudinal, elastic wave travels through a cylindrical, isotropic bar is given by c_{L}=\sqrt{E/ρ}, where E and ρ are the Young's modulus and mass density, respectively. Similarly, an elastic, shear wave travels through the same media at a speed given by c_{S}=\sqrt{G/ρ} where the shear modulus,

$$G = \frac{E}{2 ( 1 - v )} .$$

Substitution of the typical steel values given above yields c_{L}=5.152×10³ m/s and c_{S}=3.196×10³ m/s.

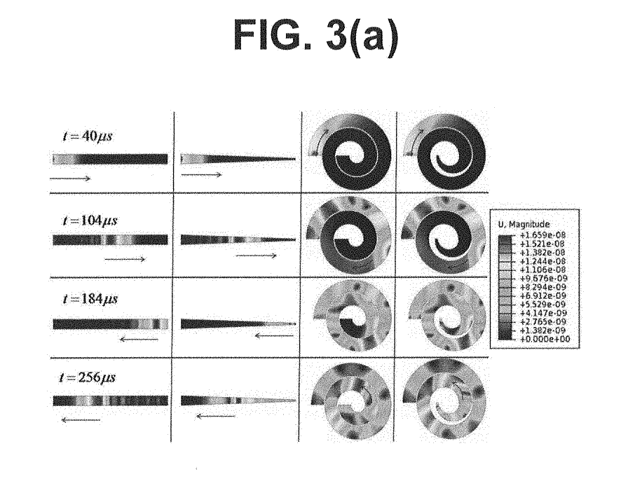

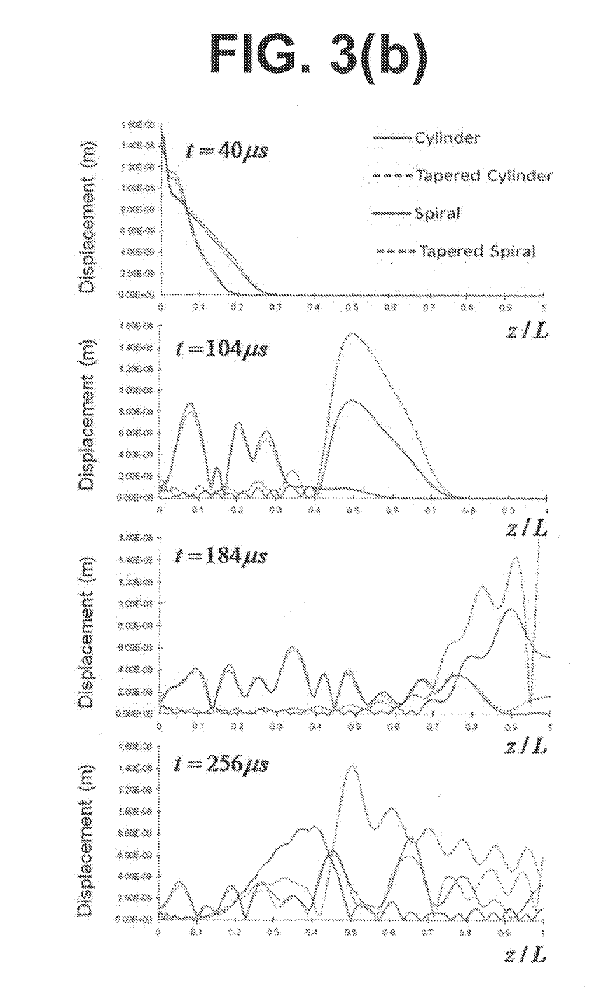

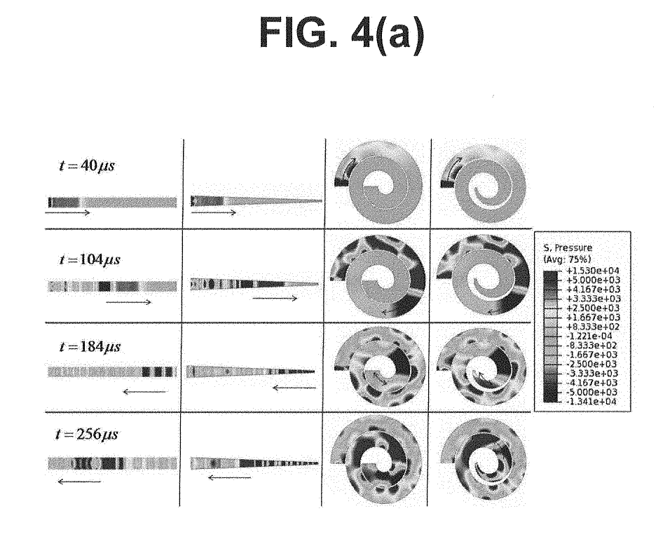

Displacement contour and wave propagation plots for the cylinder, tapered cylinder, spiral, and tapered spiral are shown in FIG. 3. The plots for t=40 μs show the initial wave immediately after the pressure load is released. At t=104 μs, the wave is traveling in the +Z direction. The wave reaches the free end of the tapered cylinder at t=184 μs. At 1=256 μs, the reflected wave is traveling in the −Z direction on its way back to the fixed end. And at t=328 μs, the wave peak reaches the fixed end of the cylinder where it had originated. Similar plots for pressure and the von Mises stress invariants are provided in FIG. 4 and FIG. 5, respectively.

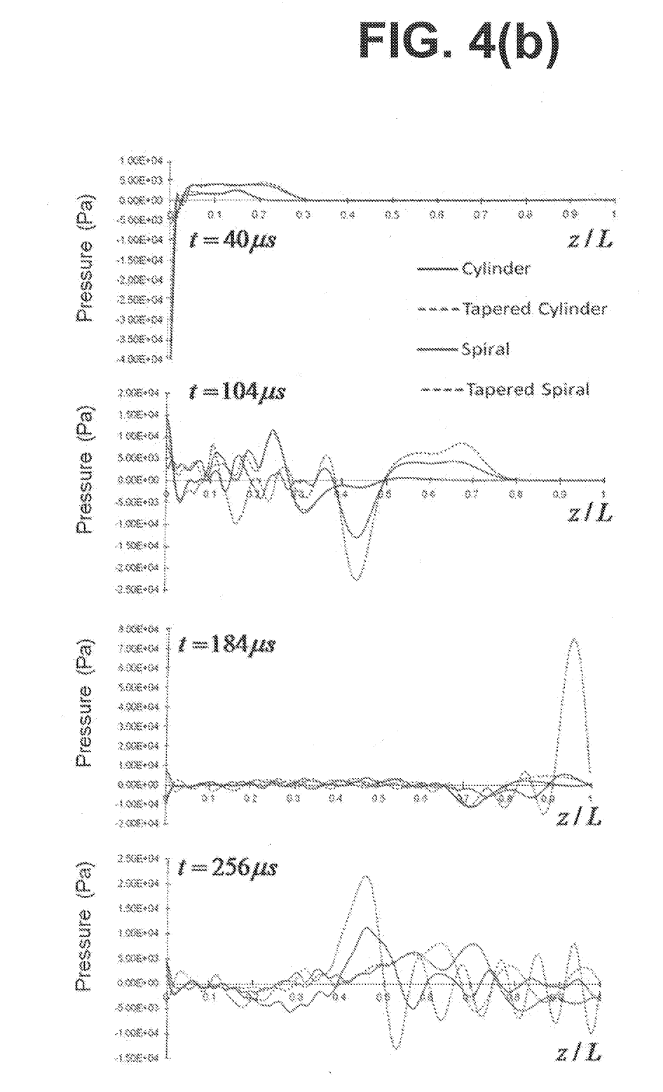

FIG. 6(a) shows the pressure response at the free end of the cylinder, tapered cylinder, spiral, and tapered spiral. The free-end displacement response for the four geometries is shown in FIG. 6(b). On the lower abscissa, τ_{L}=t·(c_{L}/L)=1 is the time at which the longitudinal wave first reaches the free end. The first and second reflected longitudinal wave arrive back at the free end at τ_{L}=3 and τ_{L}=5, respectively. Similarly, on the upper abscissa, τ_{S}=t·(c_{S}/L)=1 corresponds to the time at which the shear wave reaches the free end and τ_{S}=3 represents the arrival of the reflected wave back to the free end.

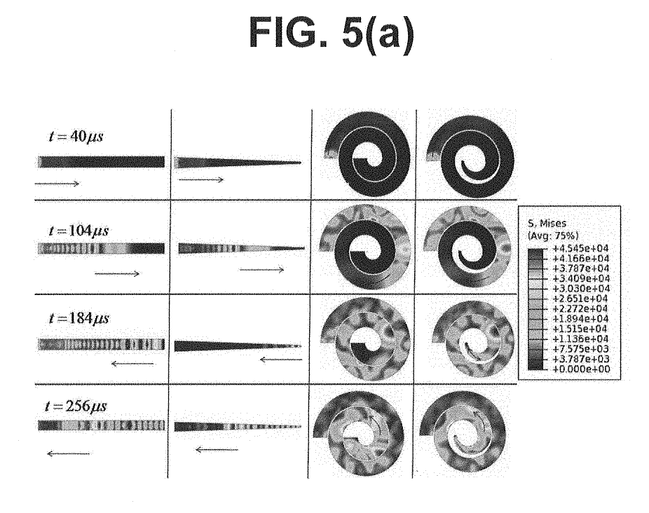

FIG. 7(a) compares the normalized impulse at the free end. The impulse is calculated by multiplication of the free-end pressure history by the respective free-end area followed by integration of the resulting force history (where negative values are neglected). FIG. 7(b) is a comparison of the normalized free-end displacement. Free-end displacement is taken as the area under the free-end displacement history curve. The free-end impulse and displacement values of the cylinder are used to normalize the results and provide simple comparison.

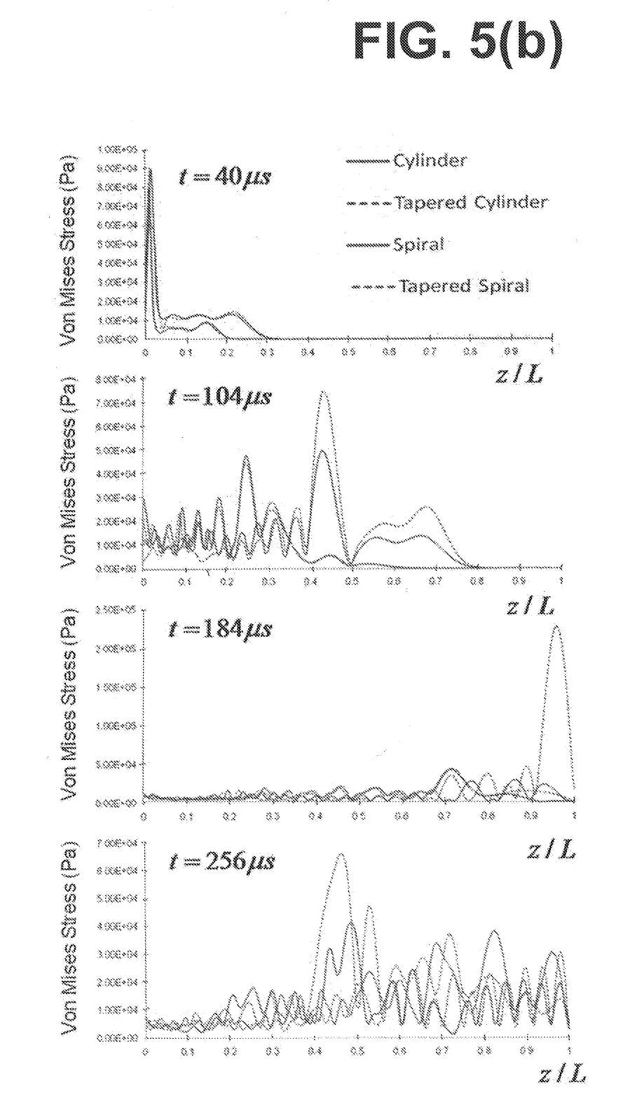

FIG. 8 shows the transverse displacement response.

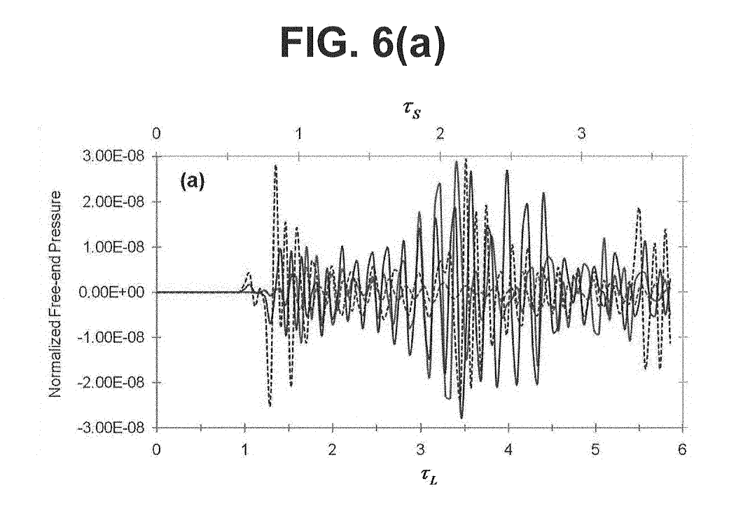

FIG. 9 shows the different scenarios of the suture within the block of material representing a simple structure. It is anticipated that any structural geometry with the suture would generate similar results. The different colors illustrate the effect of the reflections of the various boundaries along with the suture.

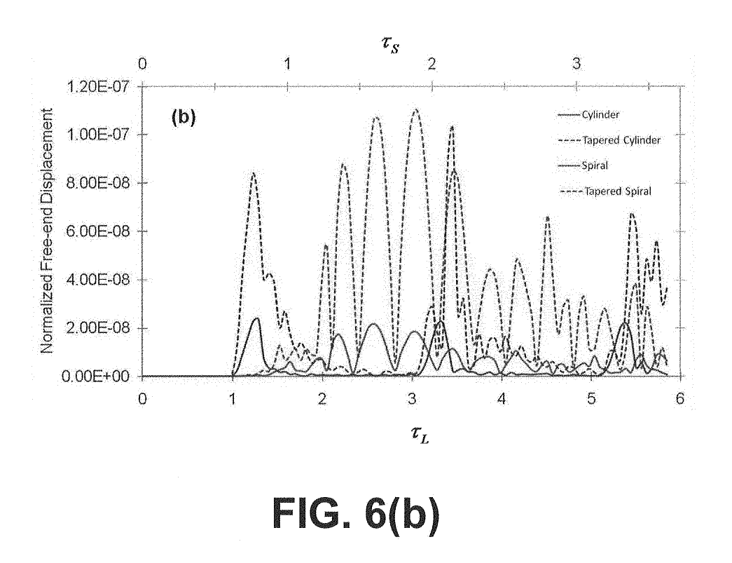

FIG. 10 shows the dramatic drop in the impulse from when the embedded wave was introduced with a single wave, a single wave with an out-of-phase wavy boundary, and a single wave with an in-phase wavy boundary. Clearly, the interactions of the embedded wavy geometries reduce dramatically the impulses (integrated pressure-time histories) much more than the straight line baseline case.

3. Analysis and Discussion

From FIG. 3, we see that at t=4 μs, the wave front is at z/L=0.3 for the cylinder and tapered cylinder. Comparing that to the position of the wave at t=104 μs, we see that, prior to any reflection from the free end, the wave travels through the cylinder and tapered cylinder at approximately the same velocity. However, the displacement amplitude is magnified by the reduction in area of the tapered cylinder. The displacement wave reaches the free end of the tapered cylinder at t=184 μs. At this same time, the wave has already reflected from the free end of the uniform cylinder and is traveling in the −Z direction.

In the two spiral geometries, there is a slight bump in the displacement at t=104 μs and z/L=0.5, but the main displacement wave in the spiral geometries lags behind the main wave in the cylinders. Also, in the spirals, there are more wave interactions as the waves reflect off the surfaces, which cause the waves to be more dispersed.

The displacement wave reaches the free end of the tapered cylinder first, at r=184 μs. At t=256 μs, the cylinder leads the tapered cylinder. The reflected wave in the tapered cylinder travels slower.

The shear wave travels slower than the longitudinal wave. Therefore, when the waves arrive at the boundary at different times, this leads to dispersion and/or cancellation and lower impulse near the free end of the rods. For the spirals t=184 μs is an interesting time because the longitudinal wave has reached the free end but the shear wave has not.

Pressure (or hydrostatic stress), as plotted in FIG. 4, is the stress that tends to change the volume of the body. Compressive stress is taken as positive and tensile stress is negative. The von Mises stress that is used to construct FIG. 5 is the second deviatoric stress invariant, i.e., the von Mises stress is the part of stress tensor that tends to distort the body and is independent of the hydrostatic stress component.

4. Conclusions Based Upon Experimental Data

The spiral shaped element and the suture are two useful ways in dissipating energy imposed upon it by an object. In general, the suture can be (a) a wavy gap in a material or material layer, (b) a wavy gap in a first material or material layer with a second material situated therein, or (c) a wavy interface between two or more parts of a material. The energy is dissipated as a shear wave by vibration of the spiral shaped element and/or the suture. Furthermore, the tapered spiral shaped element is better at dissipating impact energy than the spiral shaped element having uniform circular cross section throughout its length. Also, when multiple sutures are introduced within a material, more dissipation occurs as well.

The impact can occur from any direction (and any angle), and the spiral shaped element and/or suture will dissipate the impact energy.

The spiral shaped elements and the suture can be made out of numerous possible materials. Any material that will enable vibration can be used including, but not limited to, elastic, viscoelastic, plastic, etc.

Shock mitigating materials can be manufactured to include one or more of the spiral shaped elements or sutures. For example in the case of a helmet, such as a football helmet, a helmet layer or football helmet pad insert can be produced with one or more, but preferably numerous, spiral shaped elements in order to dissipate energy when a football player wearing the helmet is impacted. The outer shell of the helmet can also be further supplemented to have embedded wavy materials or gaps included in the design to help further dissipate impact energy by transforming the impact energy into shear waves.

An example of a shock mitigating material with spiral shaped elements used in a helmet is shown and described in commonly assigned U.S. patent application Ser. No. 14/694,715, filed Apr. 23, 2015, which is incorporated herein by reference. FIGS. 1 and 2A of the application illustrate the spiral elements 223.

In the shock mitigating materials, the spiral shaped elements can be situated in or surrounded by air, liquids, gel, elastic, viscoelastic, plastic, or any other material that permits the spiral shaped element to vibrate for the purpose of dissipating impact energy. Furthermore the suture can include, air, liquids, gels, viscoelastic, plastic, or any other material that admits the wave to dissipate.

B. Second Experimental Study—Stress Wave Mitigation at Suture Interfaces

This study investigated the stress wave dissipation in sinusoidal patterned suture interfaces that were inspired by sutures in biological materials. Finite element results showed that a sutured interface decreased the pressure 37% more at an un-sutured interface, which arose from wave scattering and greater energy dissipation at sinusoidal boundaries. Stress wave scattering resulted in converting compressive waves (S11) into orthogonal flexural (S22) and shear waves (S12), which decreased both the peak pressure (attenuation) and wave speed (dispersion). Higher strain energy occurring at sutured interfaces brought energy loss within the viscoelastic gap, too. In addition, the inventors parameterized several variables related to the suture interfaces for their influence in stress wave mitigation. The following seven parameters were examined: (1) waviness of suture (ratio of suture height to suture period), (2) ratio of the suture height over the entire bar thickness, (3) gap thickness, (4) elastic modulus, (5) type of the boundary, (6) impact amplitude, and (7) impact duration. The final result of the parametric study revealed that the high ratio of the suture over the entire bar thickness had the greatest influence, followed by the short impact duration, and then by the low elastic modulus. Additionally, a high ratio of the suture over the entire bar thickness and low elastic modulus decreased the stress wave velocity as well. These findings can be applied for designing various synthetic damping systems so that man-made engineering designs can implement the optimized sutures for impact scenarios.

1. Highlights

The capability of stress wave dissipation at sinusoidal patterned suture interfaces inspired by biological materials was examined.

A bar with a suture interface attenuated stress waves about 37% more than a bar with a flat interface.

Damping is believed to occur by two mechanisms: (i) Wave scattering at the suture interface in which impending compressive waves (S11) converted into flexural (S22) and shear waves (S12), and (ii) energy loss within the strain energy of the viscoelastic gap.

The ratio of the suture height to the bar thickness is the main variable in designing a sinusoidal interface regarding stress dissipation.

2. Introduction

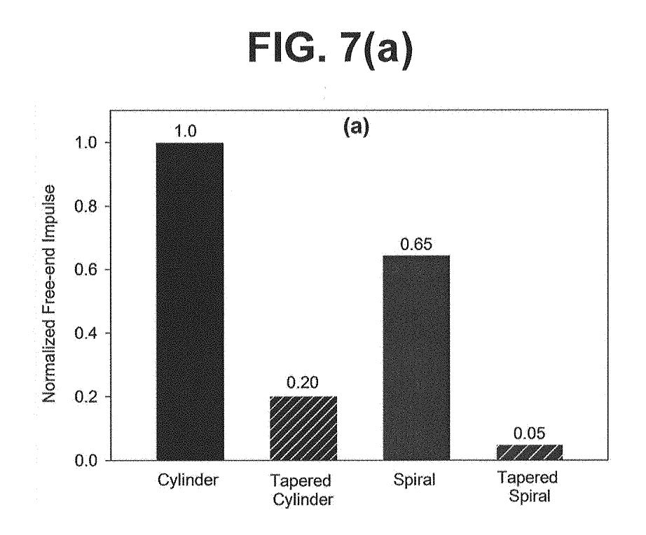

Biological materials are remarkably designed for efficient mechanical behavior. One elegant example is a suture joint, which is a simple yet multifunctional geometry. In biological structures, suture joints are commonly found where two stiff components interlock each other. For example, within the microstructure of the woodpecker beak, a wavy sinusoidal-geometry was observed under the transmission electron microscope (FIG. 11(a)). Compared to other birds, whose beaks' impact resistance is less than that of woodpeckers, the waviness of suture shown in woodpeckers' beaks is greater (Lee, N., Horstemeyer, M., Rhee, H., Nabors, B., Liao, J., Williams, L. N., 2014. Hierarchical multiscale structure—property relationships of the red-bellied woodpecker (Melanerpes carolinus) beak. Journal of The Royal Society Interface 11, 20140274).

FIG. 11(b) shows bison's cranial suture, which has been extensively researched. Researchers reported that cranial sutures provide flexibility for growth, movement, and strain due to masticatory and impact energy dissipation (Behrents, R. G., Carlson, D. S., Abdelnour, T., 1978. In vivo analysis of bone strain about the sagittal suture in Macaca mulatta during masticatory movements. Journal of Dental Research 57, 904-908; Byron, C. D., 2006. The role of the osteoclast in cranial suture waveform patterning. The Anatomical Record Part A: Discoveries in Molecular, Cellular, and Evolutionary Biology 288A, 552-563; Curtis, N., Jones, M., Evans, S., O'Higgins, P., Fagan, M., 2013. Cranial sutures work collectively to distribute strain throughout the reptile skull. Journal of The Royal Society Interface 10; Herring, S. W., Teng, S., 2000. Strain in the braincase and its sutures during function. American Journal of Physical Anthropology 112, 575; Hubbard, R. P., Melvin, J. W., Barodawala, I. T., 1971. Flexure of cranial sutures. Journal of biomechanics 4, 491-492, IN491-IN493, 493-496; Jaslow, C. R., 1990. Mechanical propertise of cranial sutures. J Biomechanics 23, 313-321; Opperman, L. A., 2000. Cranial sutures as intramembranous bone growth sites. Developmental dynamics 219, 472-485; Seimetz, C. N., Kemper, A. R., Duma, S. M., 2012. An investigation of cranial motion through a review of biomechanically based skull deformation literature. International Journal of Osteopathic Medicine 15, 152-165; Sun, Z., Lee, E., Herring, S. W., 2004. Cranial sutures and bones: growth and fusion in relation to masticatory strain. The Anatomical Record Part A: Discoveries in Molecular, Cellular, and Evolutionary Biology 276, 150-161; Yu, J. C., Borke, J. L., Zhang, G., 2004. Brief synopsis of cranial sutures: Optimization by adaptation. Seminars in Pediatric Neurology 11, 249-255).

As shown in FIG. 11(c), the ammonoid fossil also shows a wavy structure with a hierarchical fractal pattern on its shell. The suture of the ammonoid fossil has been studied to investigate its mechanical role and relation between hierarchical structures of sutures and function (Allen, E., 2007. Understanding Ammonoid Sutures: New Insight into the Dynamic Evolution of Paleozoic Suture Morpholog. Cephalopods Present and Past: New Insights and Fresh Perspectives, 159-180; Allen, E. G., 2006. New approaches to Fourier analysis of ammonoid sutures and other complex, open curves. Paleobiology 32, 299; Ubukata, T., Tanabe, K., Shigeta, Y., Maeda, H., Mapes, R. H., 2010. Eigenshape analysis of ammonoid sutures. Lethaia 43, 266-277). De Blasio reported that complex suture lines dramatically diminished the strain and the stress in the phragmocone such that suture fluted septum reinforced the shell against hydrostatic pressure. (De Blasio, F. V., 2008. The role of suture complexity in diminishing strain and stress in ammonoid phragmocones. Lethaia 41, 15-24).

The turtle shell also has suture joints in its carapace as shown in FIG. 11(d). Krauss, et al. conducted three-point bending tests on the suture-contained turtle bony shell and reported that the turtle shell withstands small loads by low-stiffness deformation and becomes much stiffer when the external load increases beyond a certain threshold. (Krauss, S., Monsonego Oman, E., Zelzer, E., Fratzl, P., Shahar, R., 2009. Mechanical Function of a complex three dimensional suture joining the bony elements in the shell of the red eared slider turtle. Advanced Materials 21, 407-412). The suture of the leatherback turtle was also studied and revealed that the suture caused the balance between tension and shear and brought structural flexibility by causing angular displacement (Chen, I. H., Yang, W., Meyers, M. A., 2015. Leatherback Sea Turtle Shell: A Tough and Flexible Biological Design. Acta biomaterialia).

Mechanically, the wavy suture can greatly enhance the strength of materials. Jaslow experimentally studied mechanical properties of sutures and reported that the suture increased bending strength. (Jaslow, C. R., 1990. Mechanical properties of cranial sutures. J Biomechanics 23, 313-321). Similar results on the tensile strength and bending strength have been reported as the suture plays a key role as an additive to increase strength (Li, Y., Ortiz, C., Boyce, M. C., 2011. Stiffness and strength of suture joints in nature; Li, Y., Ortiz, C., Boyce, M. C., 2012b. Bioinspired, mechanical, deterministic fractal model for hierarchical suture joints. Physical Review, E Phys Rev E 85, 031901; Li, Y., Ortiz, C., Boyce, M. C., 2013. A generalized mechanical model for suture interfaces of arbitrary geometry. Journal of the Mechanics and Physics of Solids 61, 1144-1167; Lin, E., Li, Y., Ortiz, C., Boyce, M. C., 2014a. 3D printed, bio-inspired prototypes and analytical models for structured suture interfaces with geometrically-tuned deformation and failure behavior. Journal of the Mechanics and Physics of Solids 73, 166-182; Lin, E., Li, Y., Weaver, J. C., Ortiz, C., Boyce, M. C., 2014b. Tunability and enhancement of mechanical behavior with additively manufactured bio-inspired hierarchical suture interfaces. Journal of Materials Research 29, 1867-1875). In addition, a study of an interfacial crack with hierarchical sinusoidal sutures found that sutures enhance interfacial fracture toughness under Mode-I and Mode-II loadings (Li, B.-W., Zhao, H.-P., Qin, Q.-H., Feng, X.-Q., Yu, S.-W., 2012a. Numerical study on the effects of hierarchical wavy interface morphology on fracture toughness. Computational Materials Science 57, 14-22).

Although sutures are often found in the spot that dynamic responses occur, mechanisms of aforementioned properties of sutures during impact loading have not been extensively studied. Jaslow studied energy absorption using a pendulum on the cranial sutures of head-butting goats. (Jaslow, C. R., 1990. Mechanical propertise of cranial sutures. J Biomechanics 23, 313-321). Using finite element analysis, the role of cranial sutures was investigated by Maloul et al. (Maloul, A., Fialkov, J., Wagner, D., Whyne, C. M., 2014. Characterization of craniofacial sutures using the finite element method. Journal of biomechanics 47, 245-252), who quantified how sutures redistributed the stress. Zhang and Yang pointed out that hierarchically designed cranial sutures benefited the stress attenuation and energy absorption. (Zhang, Z., Yang, J., 2015. Biomechanical Dynamics of Cranial Sutures during Simulated Impulsive Loading. Applied Bionics and Biomechanics 2015).

The main objective of this study was to investigate the geometrical effects of sinusoidal sutures on the stress wave mitigation by using Finite Element (FE) models. The following sections detail the simulation setup, results, discussion, and conclusions.

3. Simulation Set Up

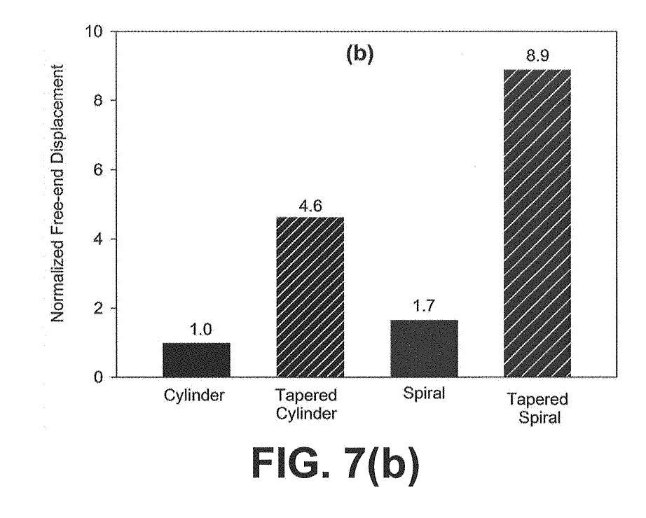

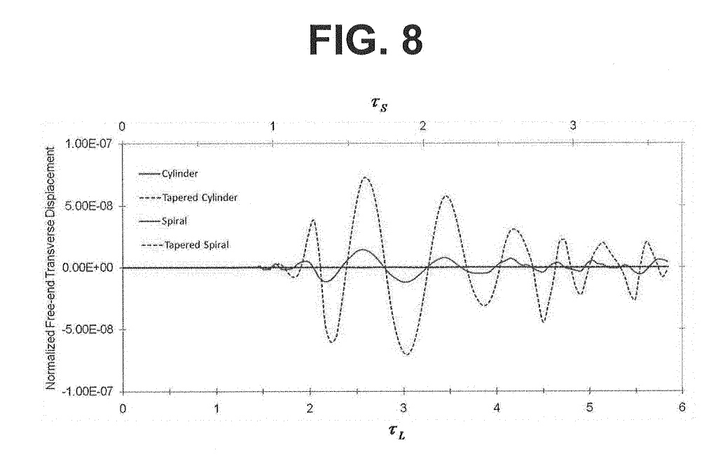

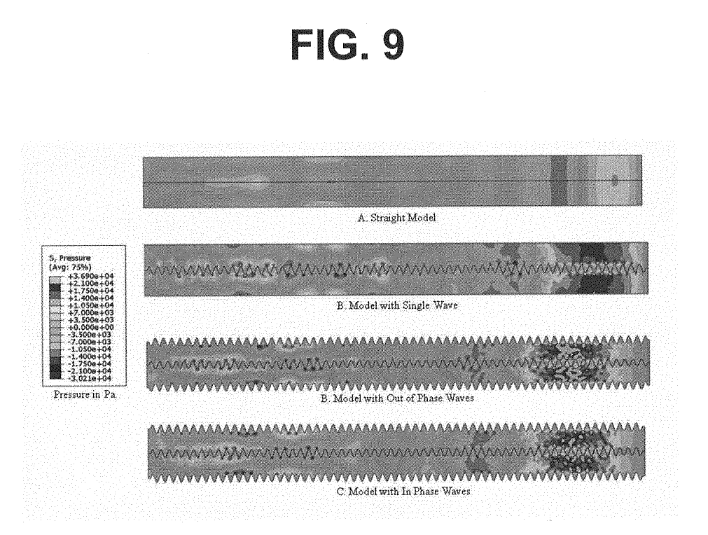

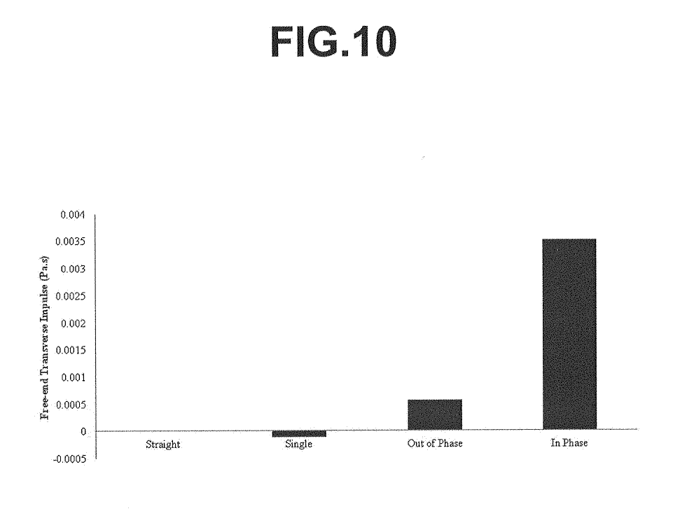

An idealized bar with a sutured interface (i.e., sutured bar) and an idealized bar with a flat interface (i.e., unsutured bar) were created and analyzed from two-dimensional Finite Element (FE) analysis in Abaqus/Explicit under dynamic conditions. As shown in FIG. 12(a) and FIG. 12(b), the dimension of the bar was 32 mm×1000 mm, in which one side of the bar was 15 mm×1000 mm with a gap thickness of 2 mm. The wall was treated as an elastic and isotropic material with Young's modulus E=8 GPa, Poisson's ratio ν=0.3, and density ρ=2000 kg/m3, and those material properties generated a longitudinal wave speed of 2000 m/s. The sutured and unsutured gaps were treated as a viscoelastic material in which the hyperelastic Ogden model was employed with the elastic parameters, μ and a, being 15.6 KPa and 21.4, respectively. (Cheng, T., Gan, R. Z., 2007. Mechanical properties of stapedial tendon in human middle ear. Journal of Biomechanical Engineering 129, 913-918). The impact load was a Gaussian impulse and applied on the left side of the bar as shown in FIG. 12(a) and FIG. 12(b) with the end nodes, on the same side, fully constrained to the y-direction. The viscoelastic properties were assigned by a Prony series with the viscoelastic parameters, d and t, being 0.549 and 6.01s, respectively, which were determined from a rat muscle study (Bosboom, E., Hesselink, M., Oomens, C., Bouten, C., Drost, M., Baaijens, F., 2001. Passive transverse mechanical properties of skeletal muscle under in vivo compression. Journal of biomechanics 34, 1365-1368). For meshing, a plane stress 4-noded element (CPS4R) was used, and the approximate element size was 0.5 mm generating about 100,000 number of elements in the 2D bar. Then, a parametric study was performed to understand the dependence of suture geometric variables and the external impact load. The seven variables were; (1) suture waviness, (2) Rsuture (ratio of the suture height to the entire bar thickness), (3) suture gap thickness, (4) elastic modulus of the wall, (5) geometry of the bar boundary walls, (6) amplitude of external impact load, and (7) impact duration, which are illustrated in FIG. 13. The detail of the experimental case is described in FIG. 13. While examining one variable, the other variables were fixed.

In order to measure the extent of dissipation in the sutured bar, pressure-time history data were recorded at eleven regions along the bar at every 100 mm, indicated by red regions in FIG. 12(c). The damping capability of the sutured bar was then evaluated through the damping quotient, which is the ratio of the pressure decay from the ‘Region-1’ compared to ‘Region-11’ as the following:

$$Damping quotient = \frac{{Pressure}_{region \text{-} 1} - {Pressure}_{region \text{-} 11}}{{Pressure}_{region \text{-} 1}} \qquad ( 1 )$$

Further, the normalized phase velocity was also analyzed to investigate the influence of sutures on wave dispersion. The following is the equation for the normalized velocity:

$$Normalized velocity = \frac{Phase velocity at current bar}{Phase velocity at un \text{-} sutured bar} \qquad ( 2 )$$

4. Results and Discussion

FE simulations were carried out by applying external mechanical loads to produce a stress wave that propagated in a continuum media. The inventors examined the damping capability of suture interfaces by comparing to an unsutured interface bar. Then the variables of the suture interfaces, such as the geometric variations and boundary conditions, were assessed by their influence on the stress wave mitigation (pressure reduction of the traveling wave within the bar).

a. Dissipation of Stress Waves in the Suture Interface

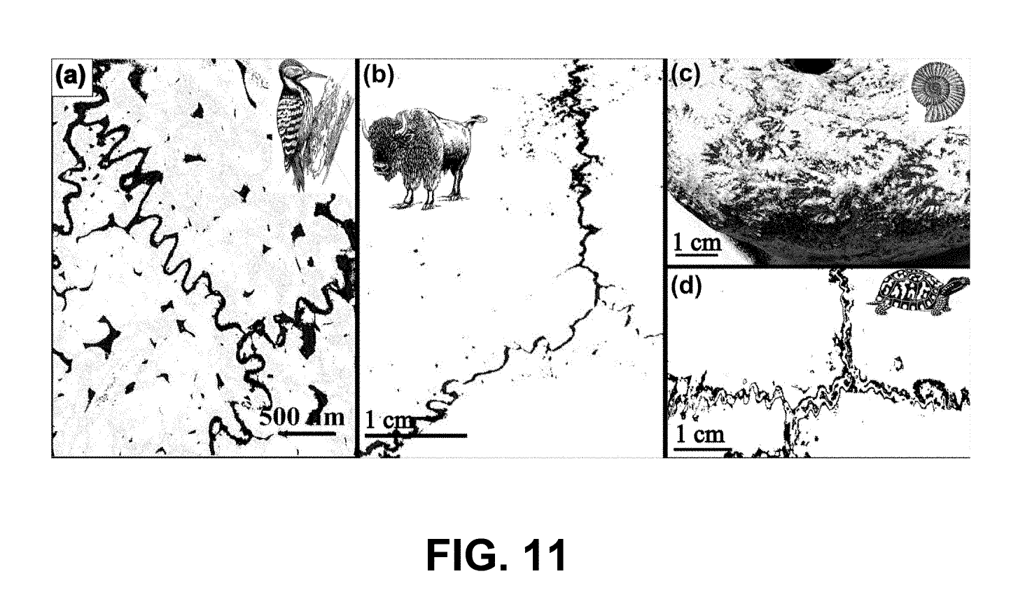

A sutured interface was able to reduce the stress wave effectively compared to an unsutured interface. FIG. 14 shows the peak pressure decay in the sutured compared to an unsutured bar. The initial load was 1 MPa, and the peak pressure when the stress wave reached the end of the bar was 0.47 MPa for the unsutured bar and 0.1 MPa at the sutured bar. While 53% of the initial pressure dissipated while the pressure wave traveled the unsutured bar, 90% of the initial pressure dissipated at the sutured bar. The sutured bar pressure was 79% less than that of the unsutured bar over the bar length used in this study.

There were two mechanisms associated with the sutured bar for stress wave mitigation as compared to the unsutured bar. First, stress wave scattering occurred at the boundary of the sutured bar, in which compressive waves (S11) were converted into shear waves (S12) and into orthogonal flexural waves (S22). From a wave perspective, there are two basic types of wave motion for mechanical waves: longitudinal waves and shear waves (also called transverse waves). Displacements in longitudinal waves occur in a parallel direction to the wave propagation, and in transverse waves, displacements occur in a perpendicular direction (Graff, K. F., 1975. Wave motion in elastic solids. Courier Dover Publications). The waves related to S11 and S22 are longitudinal waves, and the waves related to S12 are shear waves.

Wave scattering is an interaction of waves with a boundary or obstacles in a medium resulting in wave reflection, transmission, or refraction (Brekhovskikh, L. M., Goncharov, V., 2012. Mechanics of continua and wave dynamics. Springer Science & Business Media). Since the compressive incidence impinged the sinusoidal interfaces, wave scattering can be considered a reflection at a curved surface. The reflected waves consist of longitudinal and shear waves with angles of θ_{L} and θ_{S}, respectively. According to DasGupta and Hagedorn, wave scattering at boundaries can be defined as a numerical expression. (DasGupta, A., Hagedorn, P., 2007. Vibrations and waves in continuous mechanical systems. Wiley, New York). The total wave field can be represented as the following:

u(x,y,t)=A_{L0}\hat{n}_{L0}e^{iκ}^{_{L0}}^{{x sin θ}^{_{L0}}^{+y cos θ}^{_{L0}}^{-C}^{_{L}}^{t}}+A_{L}\hat{n}_{L}e^{iκ}^{_{L}}^{{x sin θ}^{_{L}}^{-y cos θ}^{_{L}}^{-C}^{_{L}}^{t}}+A_{S}â×\hat{n}_{S}e^{ik}^{_{S}}^{{x sin θ}^{_{S}}^{-y cos θ}^{_{S}}^{-C}^{_{S}}^{t}} (3)

where u is the displacement, t is the time, A is the amplitude, κ is the wave number, and θ is the angle between the waves. L0, L, and S are the incident waves, reflected longitudinal waves, and reflected shear waves, respectively. The directions of the waves are:

\hat{n}_{L0}=(sin θ_{L},cos θ_{L})^{T}

\hat{n}_{L}=(sin θ_{L},−cos θ_{L})^{T}

\hat{n}_{S}=(sin θ_{S},−cos θ_{S})^{T} (4)

Also, the speeds of the longitudinal wave and shear wave are:

$${C}_{L} = \sqrt{\frac{E}{ρ ( 1 + γ )} \frac{( 1 - γ )}{( 1 - 2 γ )}} {C}_{S} = \sqrt{\frac{E}{2 ρ ( 1 + γ )}} \qquad ( 5 )$$

where E is a Young's modulus, γ is a Poisson ratio, and ρ is a density. For given material properties in this study, C_{L}=2320.3 m/s and C_{S}=1240.3 m/s. With an assumption that a reflecting surface is a free surface, then the boundary conditions are as follows:

σ₁₂|_{y=0}=0

σ₂₂|_{y=0}=0 (6)

The boundary conditions produce the following relationships:

κ_{L0} sin θ_{L0}=κ_{L} sin θ_{L}=κ_{S} sin θ_{S}

C_{L}κ_{L0}=C_{L}κ_{L}=C_{S}κ_{S} (7)

### Then,

$${θ}_{L} = {θ}_{L 0 } {θ}_{S} = \frac{{C}_{S}}{{C}_{L}} {θ}_{L 0 } \qquad ( 8 )$$

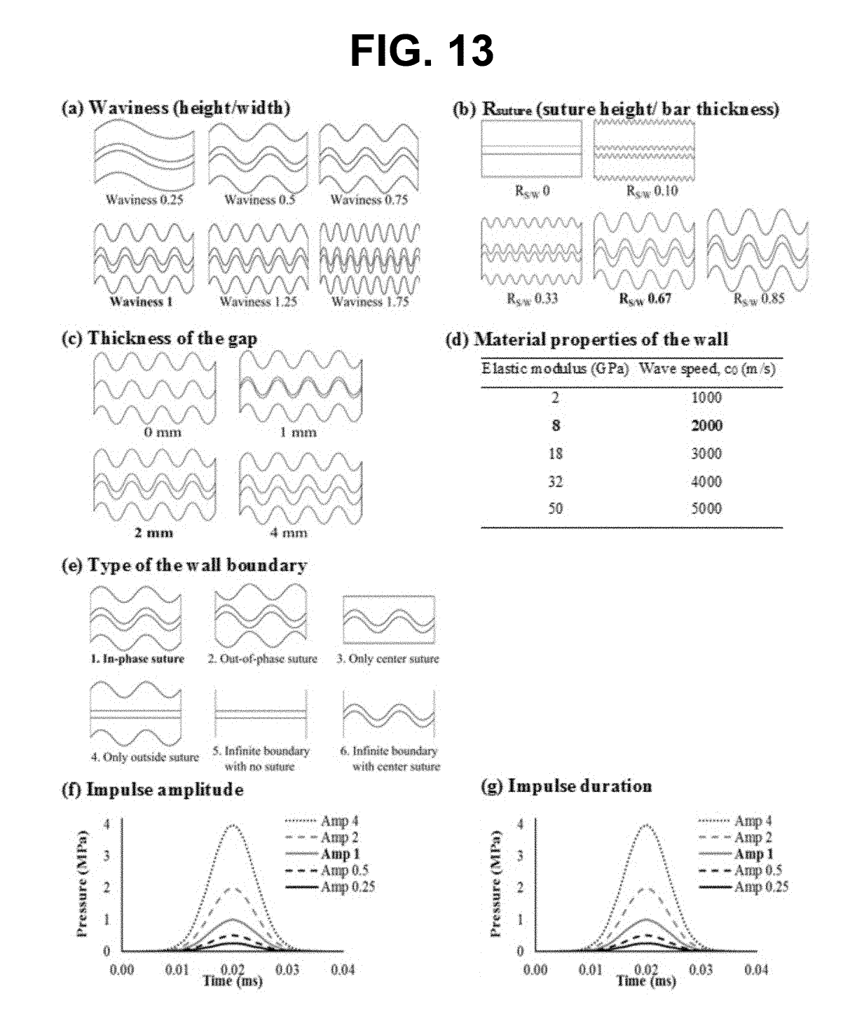

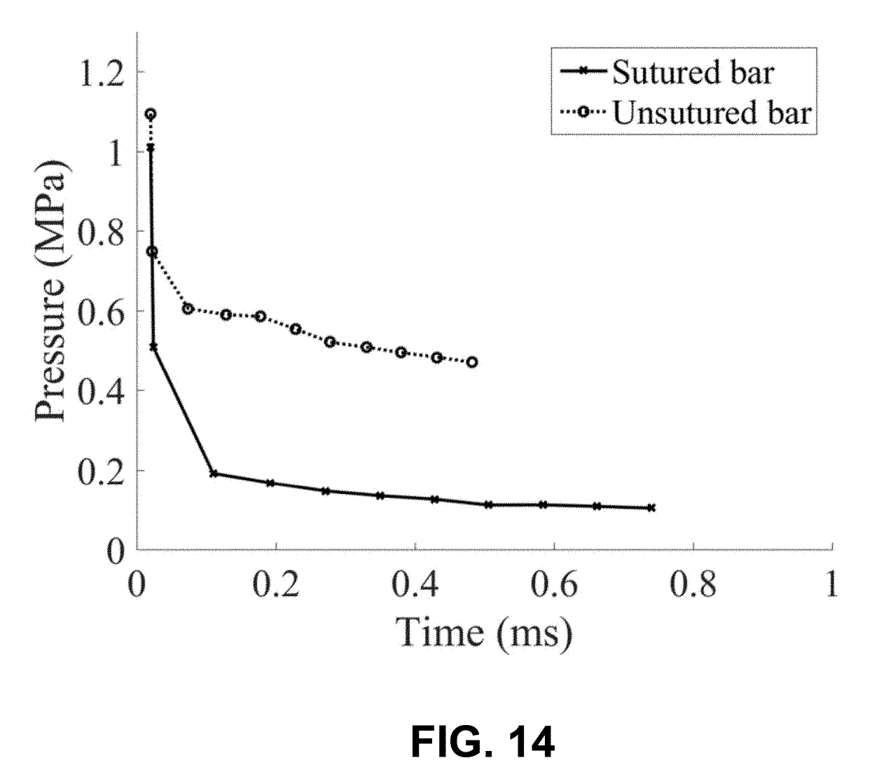

For the given conditions of this study, the angles of the reflected longitudinal waves are the same as the angles of incident longitudinal waves. On the other hand, the angles of reflected shear waves are 0.53 times the angles of the incident longitudinal waves. As a result of wave scattering at the suture interfaces, the magnitude of S11 decreased, and S12 and S22 increased (FIG. 16). The maximum S22 generated in the sutured bar was 1.58 MPa, approximately three times greater than that of the unsutured bar with S22 equaling 0.54 MPa; the maximum S12 generated in the sutured bar was 1.59 MPa, approximately five times greater than that of the unsutured bar with S12 equaling 0.29 MPa. Not only does one observe a pressure decay but also wave dispersion from wave scattering. The wave speed determined from Equation (5) above is 2000 m/s when there are no boundary effects. In the unsutured bar with boundaries, the wave speed decreased to 1818.18 m/s and arrived at 0.55 ms. Alternatively, in the sutured bar with boundaries, the wave speed decreased to 1282.05 m/s and arrived at the free end at 0.78 ms. Accordingly, the sutured bar induced y-direction longitudinal (LE22) and shear strains (LE12). FIG. 17 shows that the sutured bar induced strains in the y-direction and shear direction, but decreased strains in the x-direction.

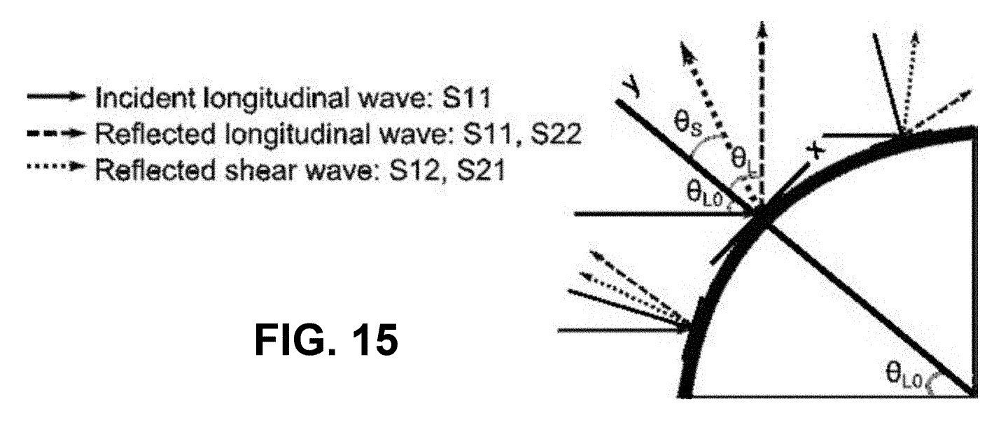

FIG. 18 shows the maximum strain energy density in the sutured and unsutured bar at Region-2 (near-front region) where the sinusoidal suture began so that the wave scattering started early. The peak strain energy was 0.09 J in the sutured bar and 0.03 J in the unsutured bar. Hence, the sutured bar incurred approximately three times greater strain energy than that of unsutured bar. Specifically, in the sutured bar, the strain energy was stored in all directions of xx (17.73%), yy (45.59%), and xy (36.68%) due to reflected stress waves, while in the unsutured bar most of the strain energy stored was only in the xx direction (86.43%).

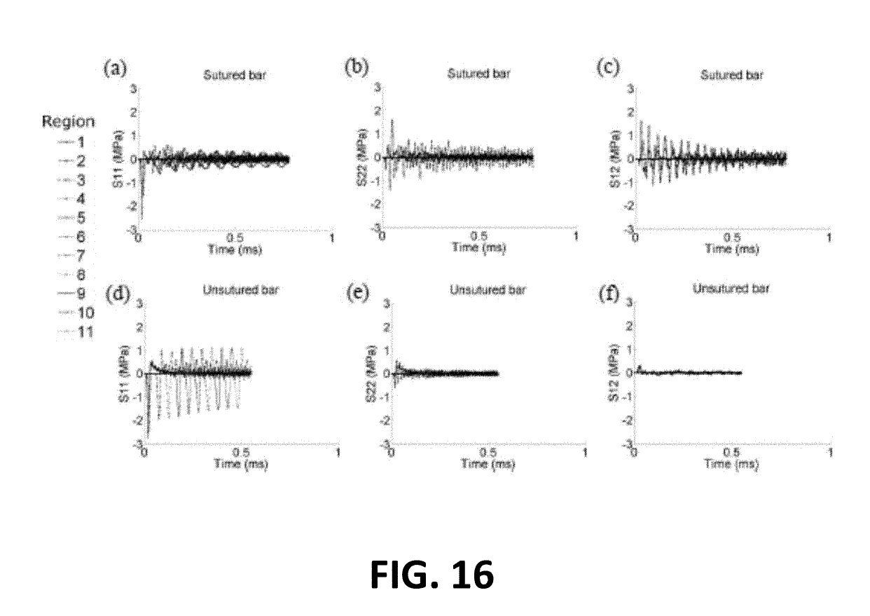

Another mechanism that reduced the amplitude of the traveling pressure wave was related to the strain energy being stored in the viscoelastic suture gap. It is common to interleave viscoelastic layers between hard and stiff material to increase the damping of the structure (Berthelot, J.-M., Assarar, M., Sefrani, Y., El Mahi, A., 2008. Damping analysis of composite materials and structures. Composite Structures 85, 189-204; Cupial, P., Niziol, J., 1995. Vibration and damping analysis of a three-layered composite plate with a viscoelastic mid-layer. Journal of Sound and Vibration 183, 99-114; Saravanos, D., Pereira, J., 1992. Effects of interply damping layers on the dynamic characteristics of composite plates. AIAA Journal 30, 2906-2913). Biological materials appear to employ the same strategy. FIG. 19 compares the strain energy of the gap between the sutured and unsutured bars. The viscoelastic gap material of the sutured bar allowed for energy dissipation since the strain energy in viscoelastic material is proportional to the damping (Plunkett, R., 1992. Damping analysis: an historical perspective. ASTM special technical publication, 562-569).

b. Design Variables Affecting the Stress Wave Mitigation

A sinusoidal patterned interface caused a local complex stress redistribution, which led to wave attenuation and wave dispersion. In order to examine the influence variables regarding a sinusoidal pattern and boundary conditions, the seven variables shown in FIG. 13 were investigated using FE analysis. For each case, a pressure decay as stress waves propagated along the bar was observed. Also, compressive waves (S11), flexural waves (S22), and shear waves (S12) were plotted to evaluate the transformation of longitudinal stress into the shear stress and flexural stress. Longitudinal waves were recorded when the pressure wave reached the end, and both of the maximum flexural waves and maximum shear waves were recorded while pressure traveled the structure. Generally, as the longitudinal wave decreased, the flexural waves and shear waves increased. As one variable changed, the other six variables were fixed with the default value indicated in FIG. 13.

(1) The Effect of the Suture Waviness

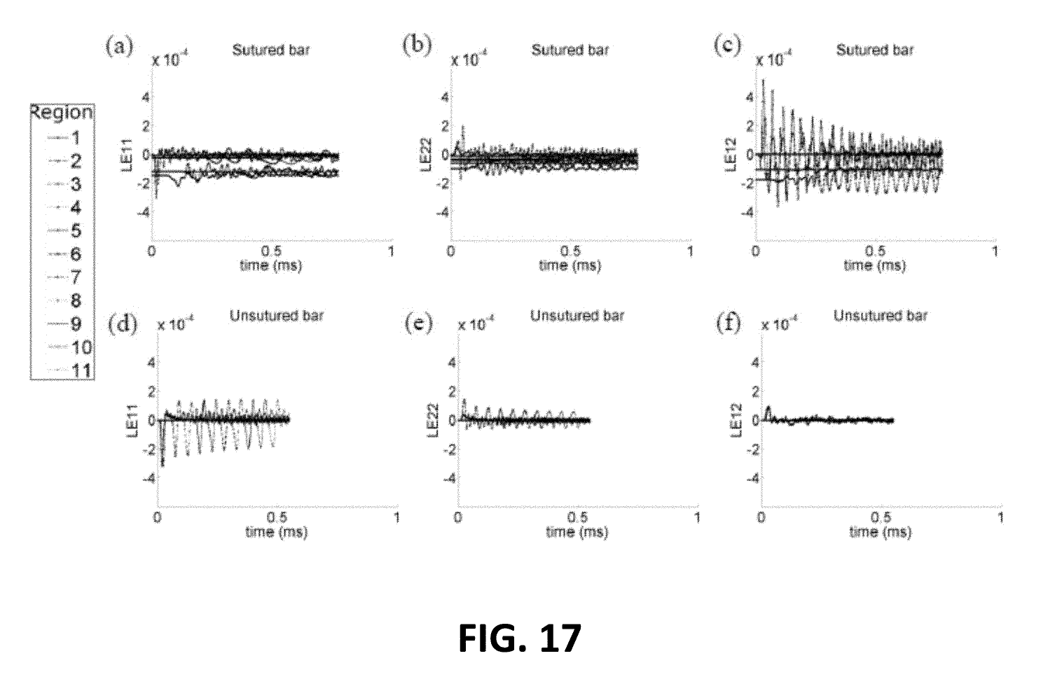

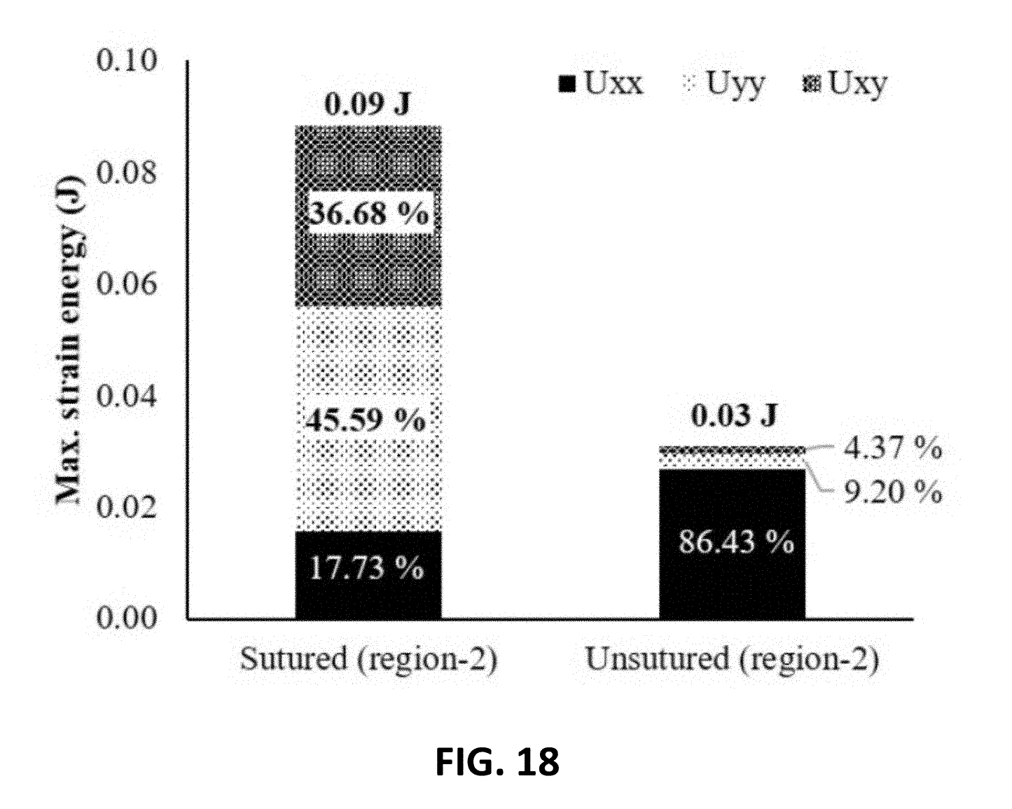

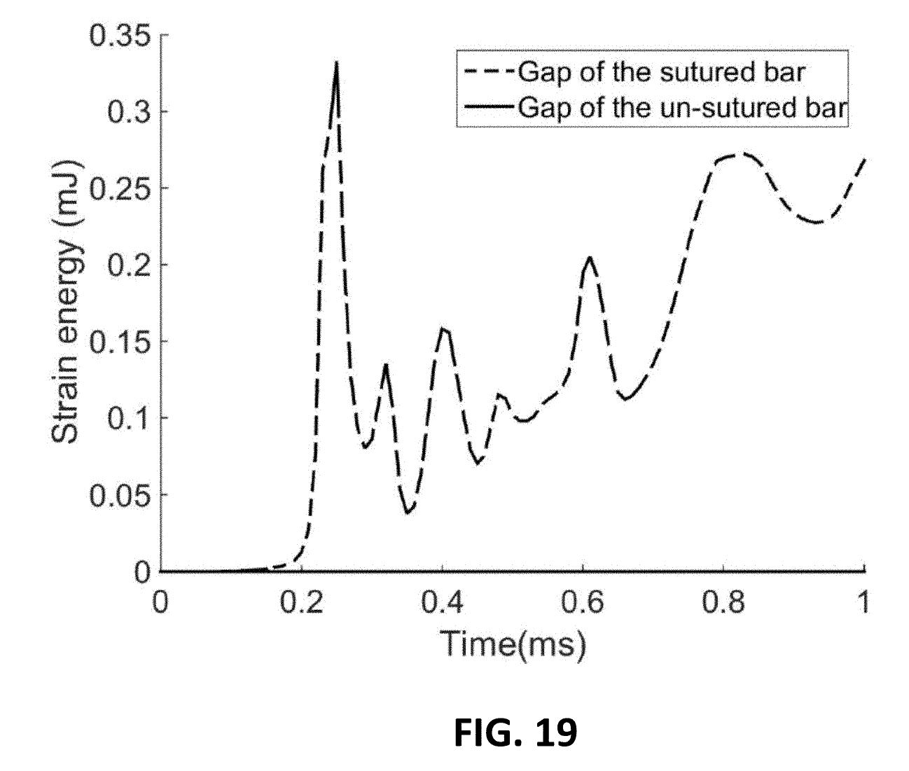

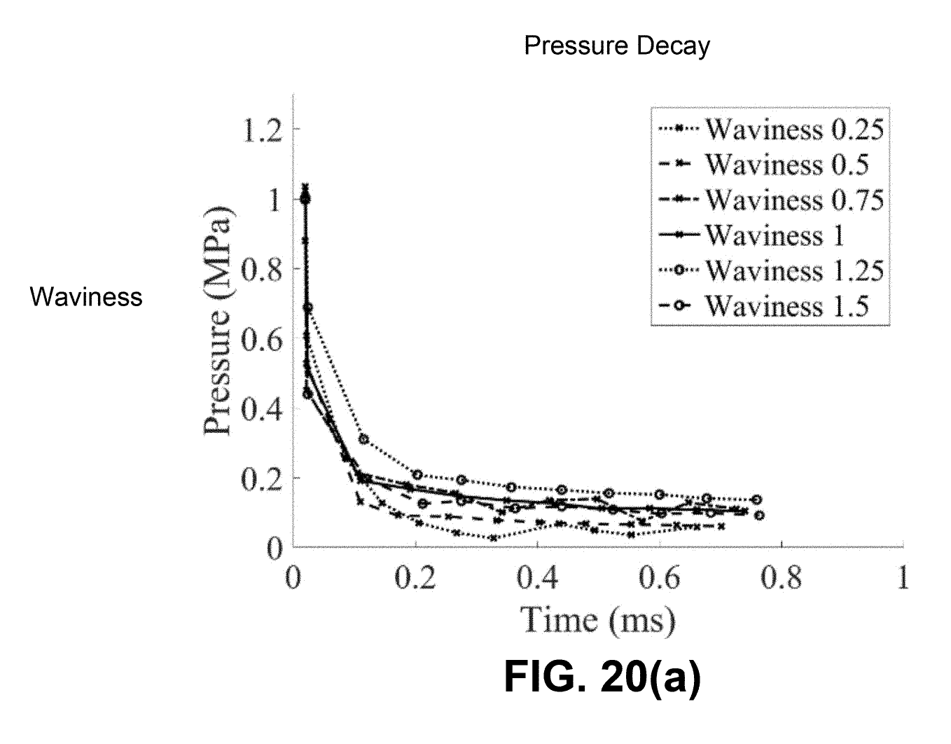

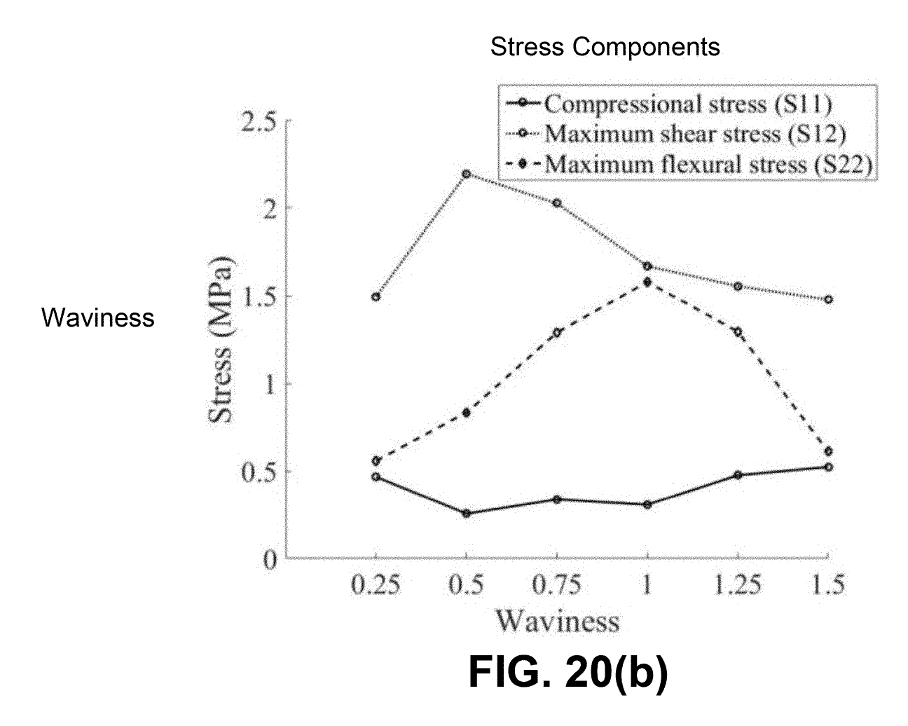

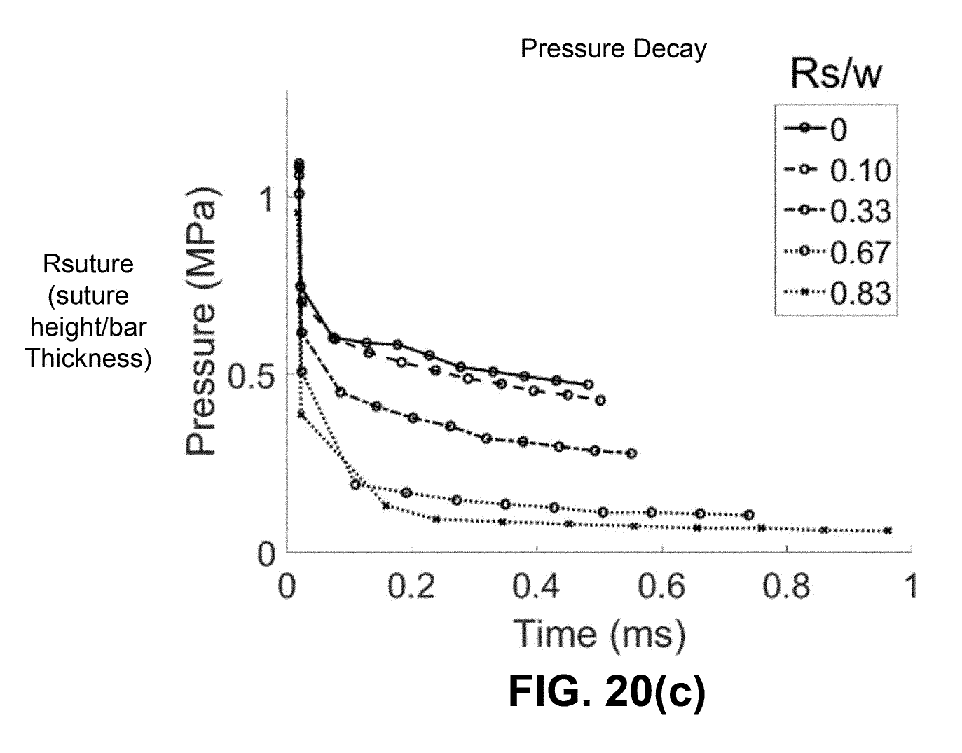

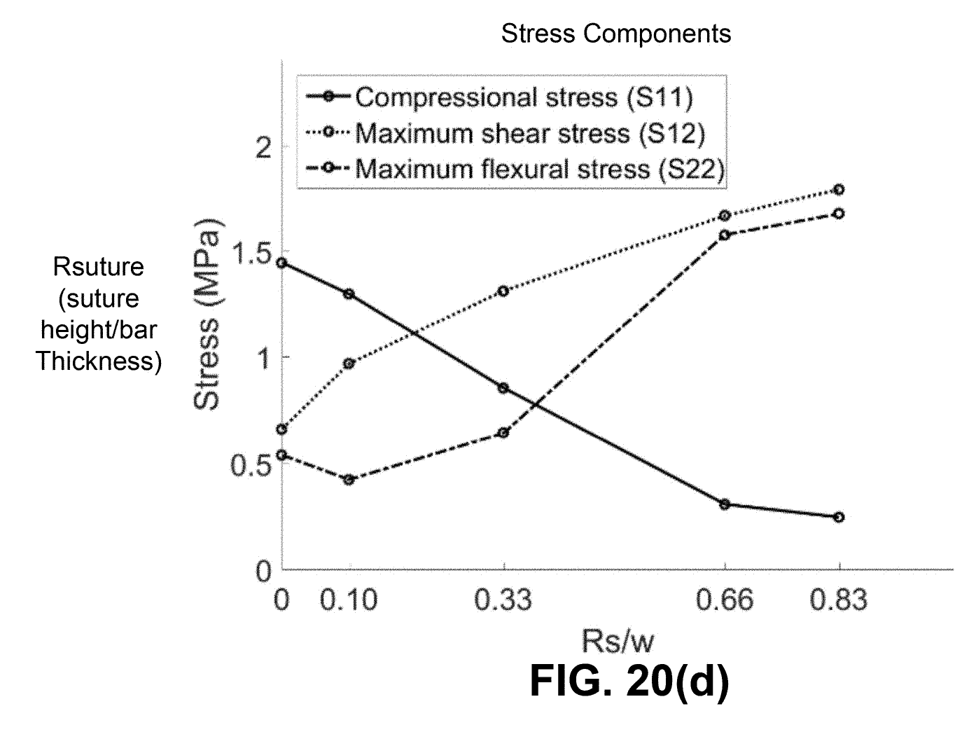

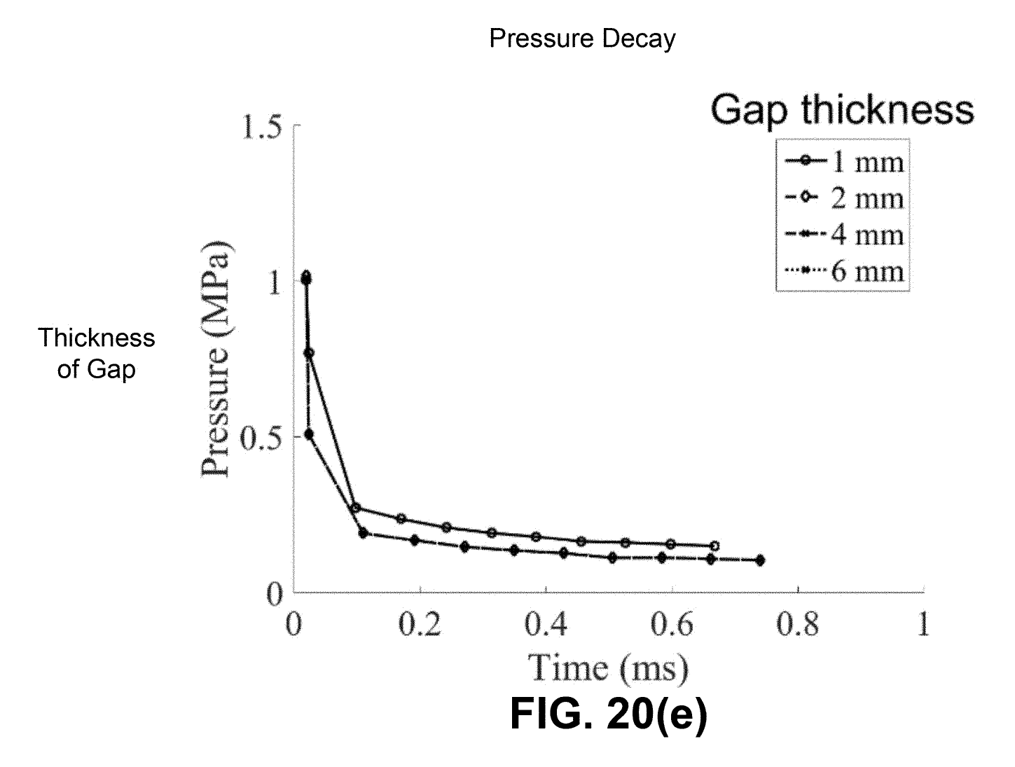

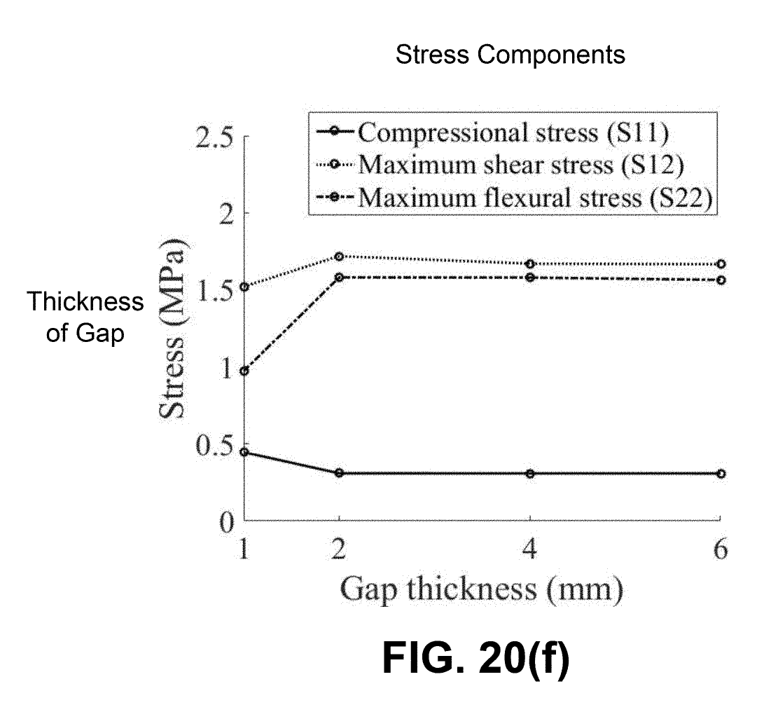

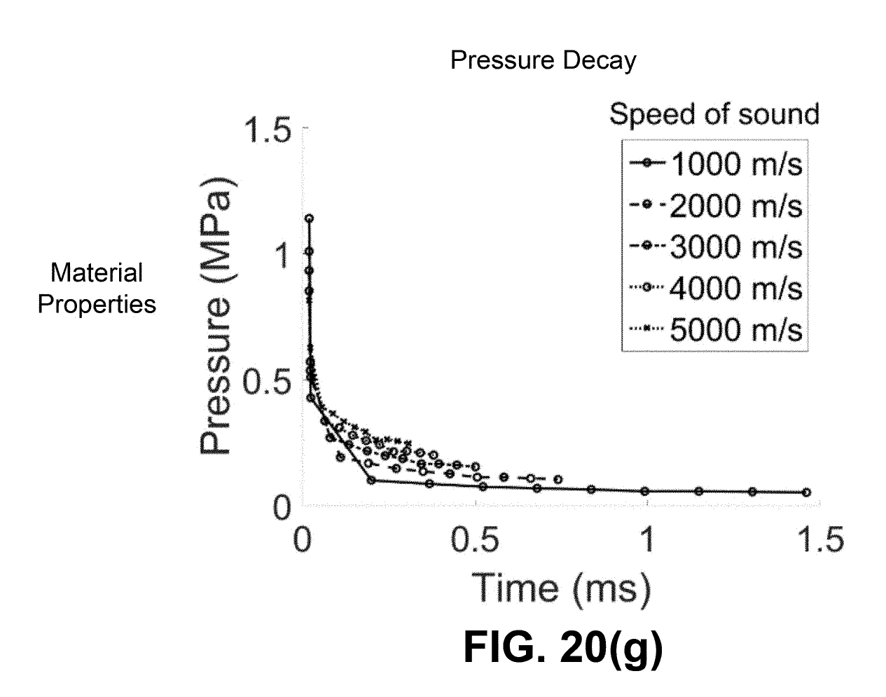

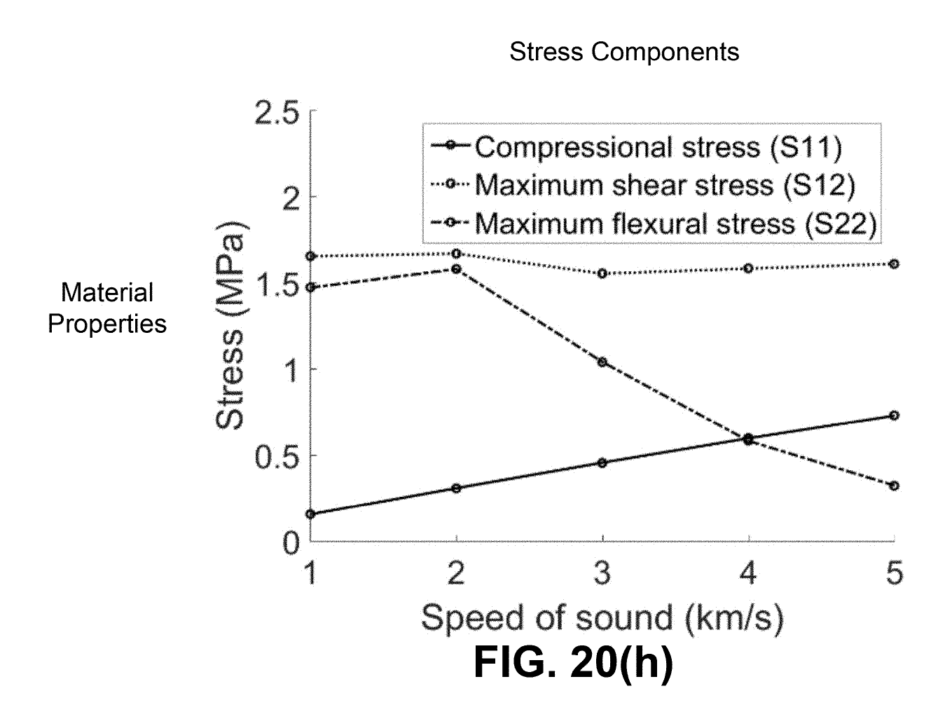

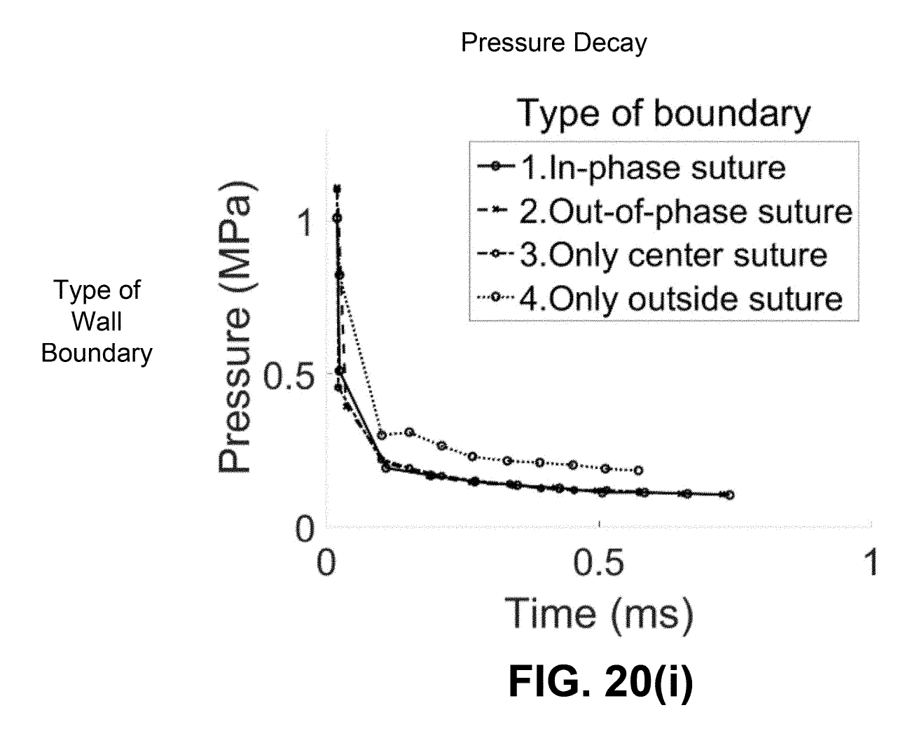

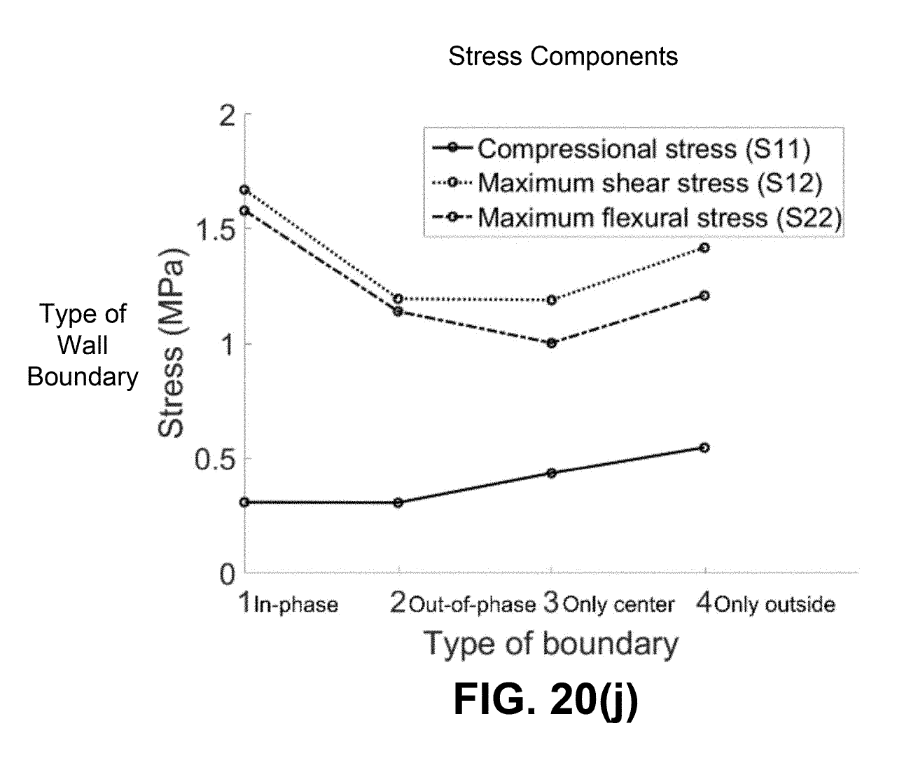

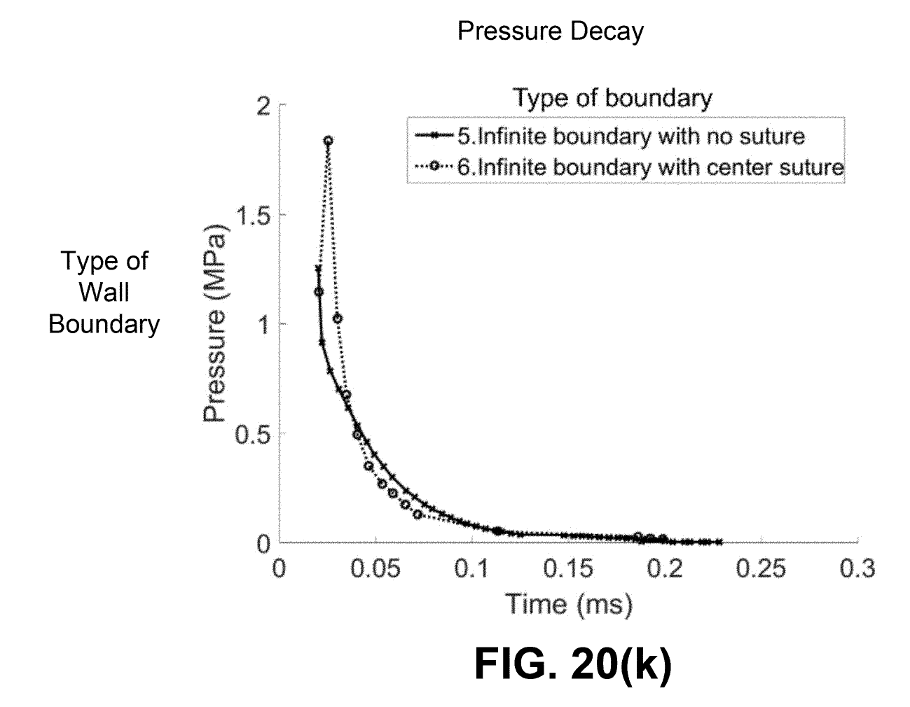

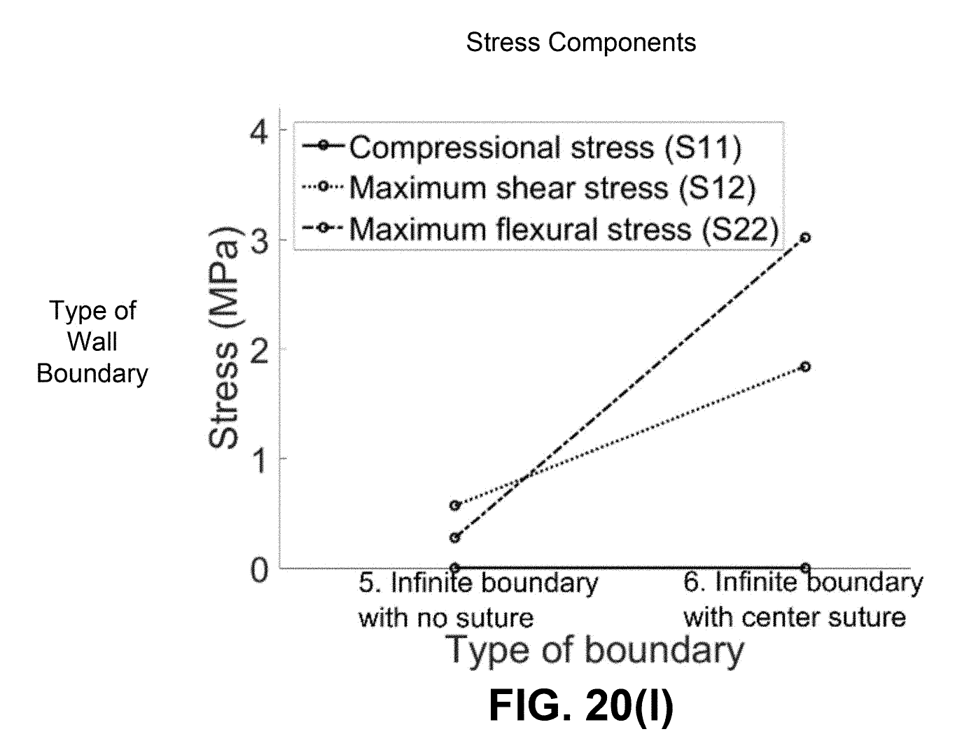

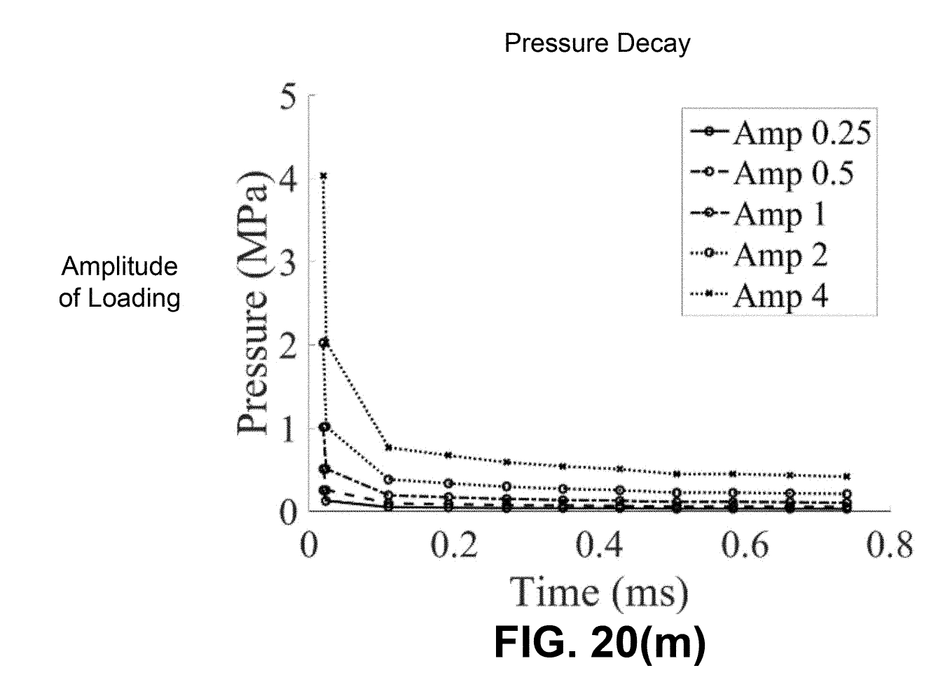

Waviness is defined as the wave height divided by the wave period. Waviness was varied in six cases of 0.25, 0.5, 0.75, 1, 1.25, and 1.5, in which the waviness height was fixed and the waviness width was changed. As the pressure wave traversed the sutured bar from the loading region to the free end, the magnitude of the pressure decreased when a suture was introduced (FIG. 4). However, with a suture, there was minimal relationship between waviness and damping as shown in FIG. 20(a). FIG. 20(b) shows that generated shear stresses incurred the largest value at a waviness ratio of 0.5 and the generated flexural wave incurred the largest value at a waviness ratio of 1. Hence, the greatest conversion from a longitudinal stress to a shear stress and flexural stress were waviness ratios of 0.5 and 1. The inventors note here that the waviness ratio shown in FIG. 11 is 1±0.32 for the woodpecker beak; 2.44±0.67 for the bison skull; 0.99±0.15 for the ammonoid shell; and 0.97±0.23 for the turtle shell.

(2) The Effect of the R_{Suture}

Rₛᵤₜᵤᵣₑ is defined as the suture height divided by the bar thickness. The Rₛᵤₜᵤᵣₑ was changed as 0, 0.10, 0.33, 0.67, and 0.83. The height of the suture was changed as 0 mm, 1.5 mm, 5 mm, 10 mm, 12.5 mm, while the bar thickness was fixed at 15 mm. As the Rₛᵤₜᵤᵣₑ increased, the pressure when the stress wave reached the end of the bar decreased as shown in FIG. 20(c). FIG. 20(d) shows that a greater Rₛᵤₜᵤᵣₑ increased the flexural stress and shear stress, but the compressional stress decreased. With respect to different animals and the human skull, the “bar thickness” would be far greater. However, the inventors were only concerned with the suture height but needed to normalize it with respect to some absolute dimension to distinguish this feature from the waviness ratio.

(3) The Effect of the Thickness of the Gap

The gap thickness varies at different length scales for the different animals. As such, the inventors varied the sutured bar's gap thickness: 1 mm, 2 mm, 4 mm, and 6 mm. The thickness of the gap did not affect the amount of stress dissipation (FIG. 20(e)) and did not show a big difference when comparing the shear stresses and flexural stresses (FIG. 20(f)), although the 2 mm, 4 mm, 6 mm of the gap thickness induced slightly more dissipation than the 1 mm gap.

(4) The Effect of the Material Properties

For the sutures in animals, the material comprises mainly collagen, a structural protein that behaves like a viscoelastic material. However, the material on either side of the viscoelastic collagen varied from bone to keratin to other biological materials. Material properties of the waveguide (the bar material in the study) determines the sound speed as the following:

$${c}_{0} = \sqrt{\frac{E}{ρ}} \qquad ( 9 )$$

In this study, five different elastic moduli were simulated: 2 GPa, 8 GPa, 18 GPa, 32 GPa, and 50 GPa, resulting in wave speeds of 1000 m/s, 2000 m/s, 3000 m/s, 4000 m/s, and 5000 m/s, accordingly. The dissipation occurred greater as the wave speed decreased (FIG. 20(g)), and the time arriving at the end of FIG. 20(h) shows that the generation of a shear wave was not affected by the wave speed while the generated flexural wave decreased as the wave speed increased. As the wave speed increased, the longitudinal compression stress proportionally increased when the stress wave reached the end of the bar.

(5) Type of Wall Boundary

The effect of the boundary was illustrated by the in-phase, out-of-phase, only center, and only outside boundaries conditions (FIGS. 20(i) and 20(j)). Stress wave dissipation was also examined with infinite boundaries of the side walls to remove the boundary effect (FIGS. 20(k) and 20(l)). FIG. 20(i) shows that there was no difference in the damping and wave speed between the in-phase and out-of-phase boundaries. However, changing the suture boundary to a straight boundary increased the wave speed independent of the centerline suture geometry or outside boundary edge. Also, the results showed that an interaction exists between the suture and the gap for damping. Suture interfaces brought greater strain energy to the gap compared to flat interfaces as discussed in connection with FIG. 18. Hence, the damping of the bar with an only-outside-suture in which the suture-gap interaction was absent was smaller than the other configurations. FIG. 20(j) shows the stress transformation at the four types of boundaries. Although the damping and wave speed were similar in in-phase and out-of-phase suture boundaries, the maximum shear stress and the maximum flexural stress were greater at the in-phase boundary than those at the out-of-phase boundary.

FIG. 20(k) shows the pressure decay for the bars with infinite boundaries on the side walls. Pressure was recorded every 10 mm, and not 100 mm, because the pressure dissipated quickly compared to the bars with finite boundaries. FIG. 20(k) demonstrates that the suture slows down the stress wave and dissipates the wave quicker than the unsutured bar. For the sutured bar, the pressure increased from the edge up to 10 mm away from the loaded edge due to the reflected S11 waves and generated S22 waves. The pressure then decreased rapidly and dissipated fully after traveling 140 mm away from the loaded edge at 0.20 ms. On the other hand, for the unsutured bar, the stress wave completely dissipated after traveling 460 mm away from the loaded edge at 0.23 ms. The calculated wave speed was 700 m/s in the sutured bar and 2000 m/s in the unsutured bar. FIG. 20(l) shows that both the generated maximum shear stress and maximum flexural stress during stress wave propagation were greater in the sutured bar than those stresses in the unsutured bar. The maximum shear stress in the sutured bar (3.02 MPa) was approximately 11.2 times greater than that in the unsutured bar (0.27 MPa), and the maximum flexural stress in the sutured bar (1.84 MPa) was approximately 3.2 times greater than that in the unsutured bar (0.57 MPa).

(6) The Effect of the Amplitude of the Impulsive Loading

The amplitude of the impact loading was changed as 0.25, 0.5, 1, 2, and 4 to investigate the damping effects caused by an input condition of amplitudes. As the amplitude of impact increased, the pressure also increased. However, the damping amounts remained the same regardless of the amplitude of the loading as shown in FIG. 20(m). FIG. 20(n) shows that as the amplitude of the loading increased, the stresses S11, S12, and S22 also increased.

(7) The Effect of the Impact Duration

The impact duration of the loaded pressure wave was changed to 0.01 ms, 0.02 ms, 0.04 ms, 0.08 ms, and 0.16 ms, respectively, in order to investigate the damping effects resulting from an input condition of different periods (and/or frequencies). Results showed that as the impact duration increased, less dissipation occurred regarding the pressure wave (FIG. 20(o)), and the compressional stress converted less to the flexural stress (FIG. 20(p)). Hence, as the impact becomes faster and faster, the effect of the suture gets greater and greater in terms of dissipating the stress wave.

c. Damping Quotient and Phase Velocity

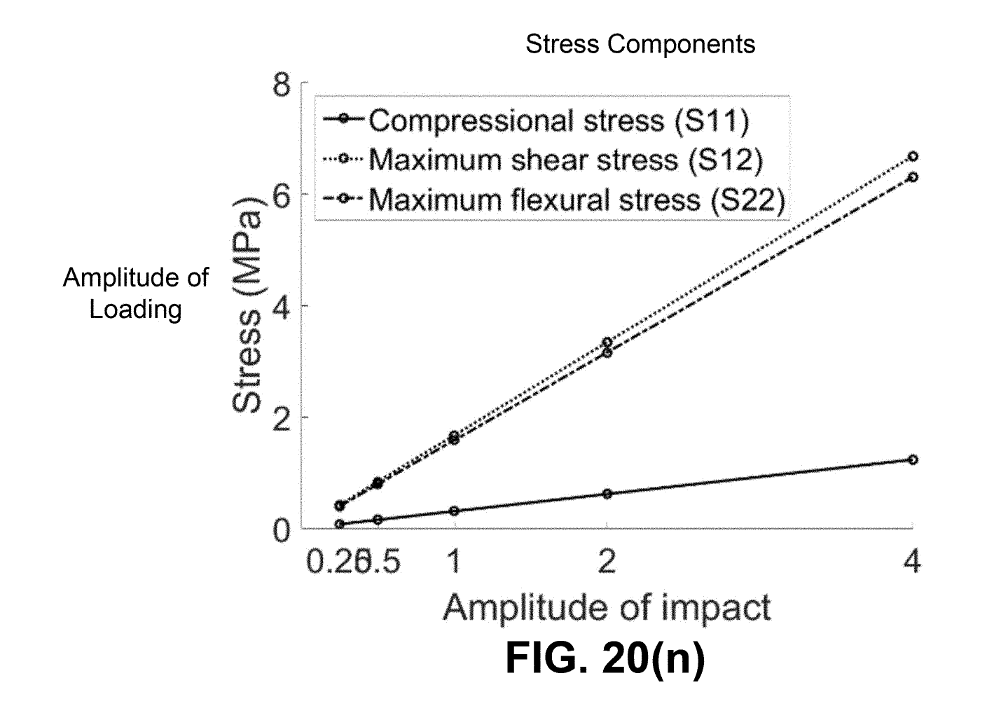

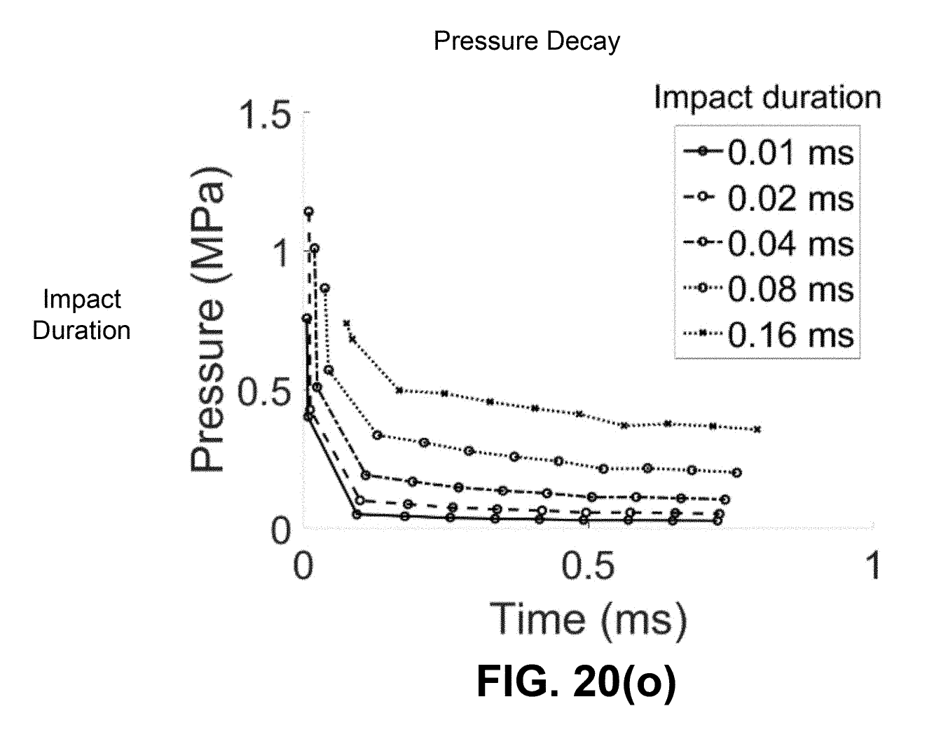

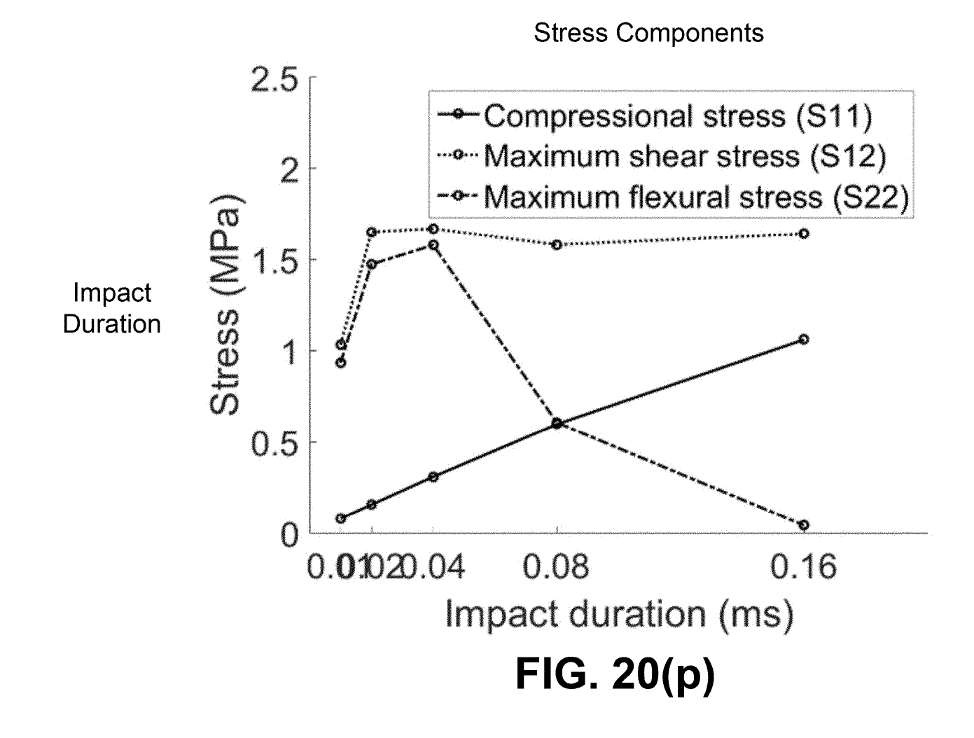

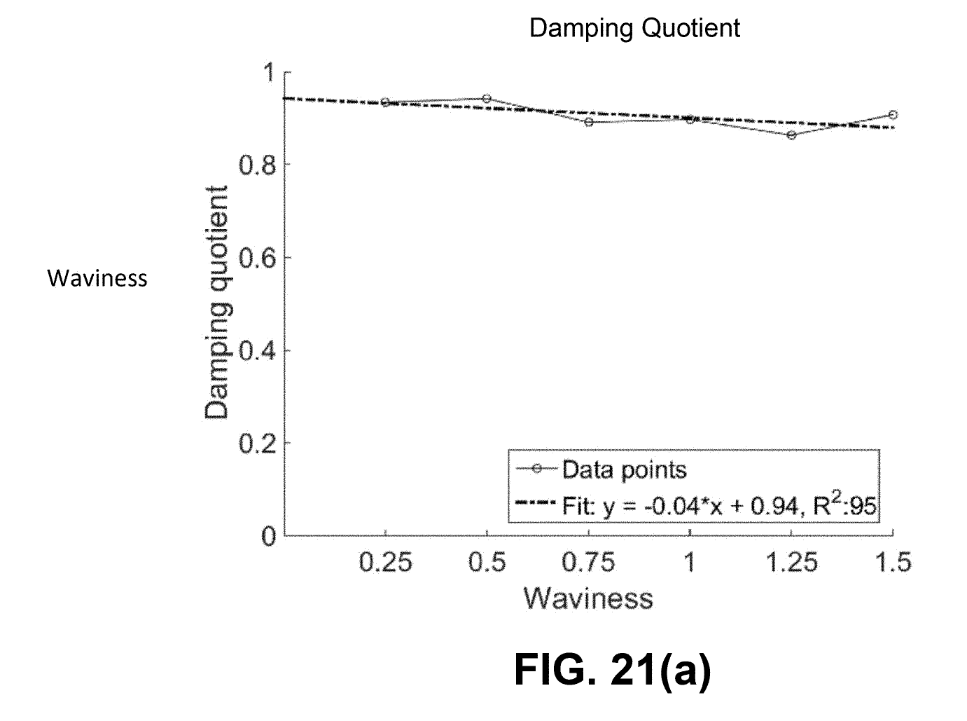

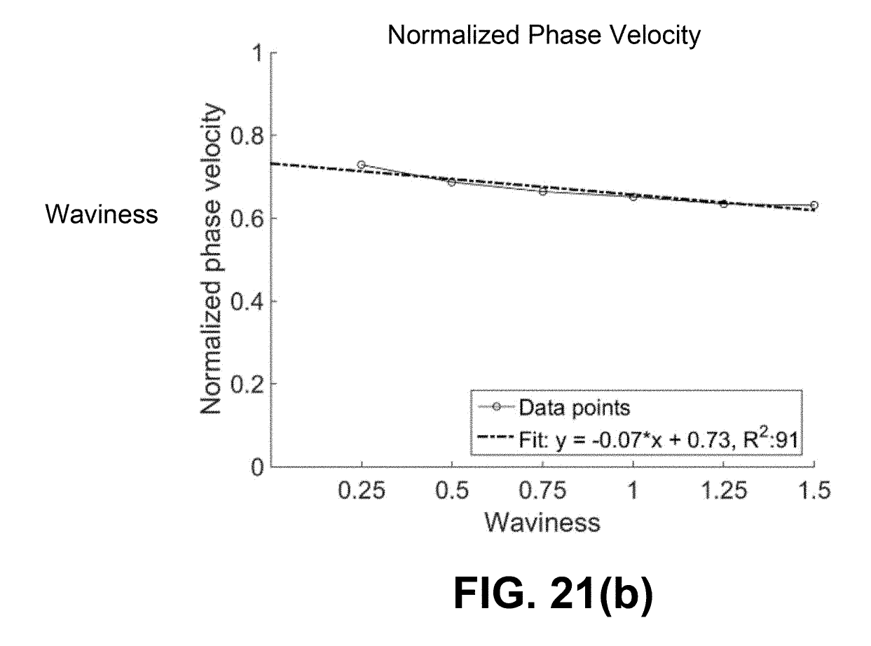

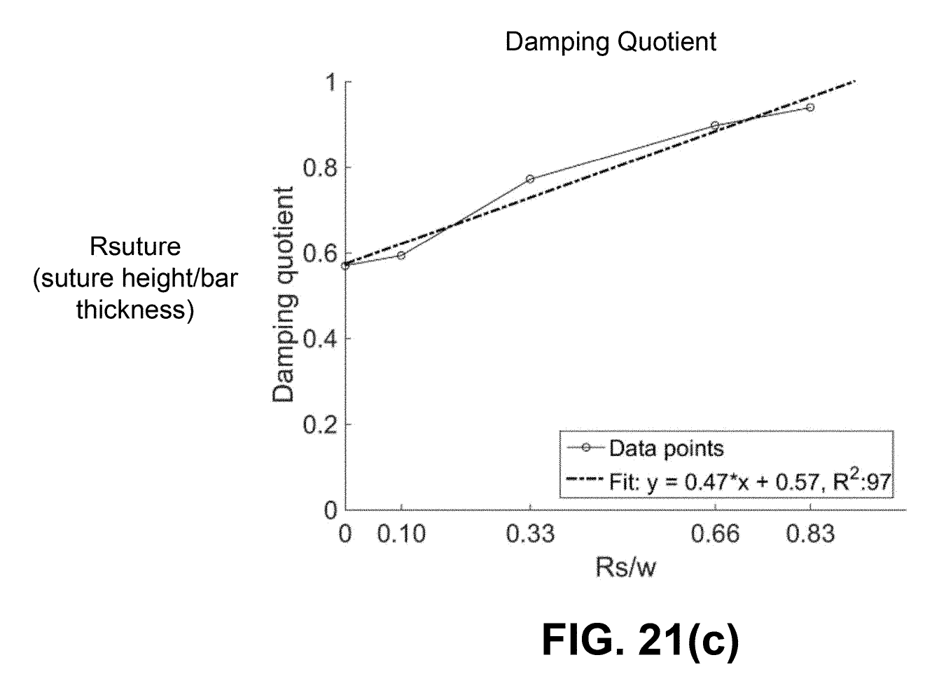

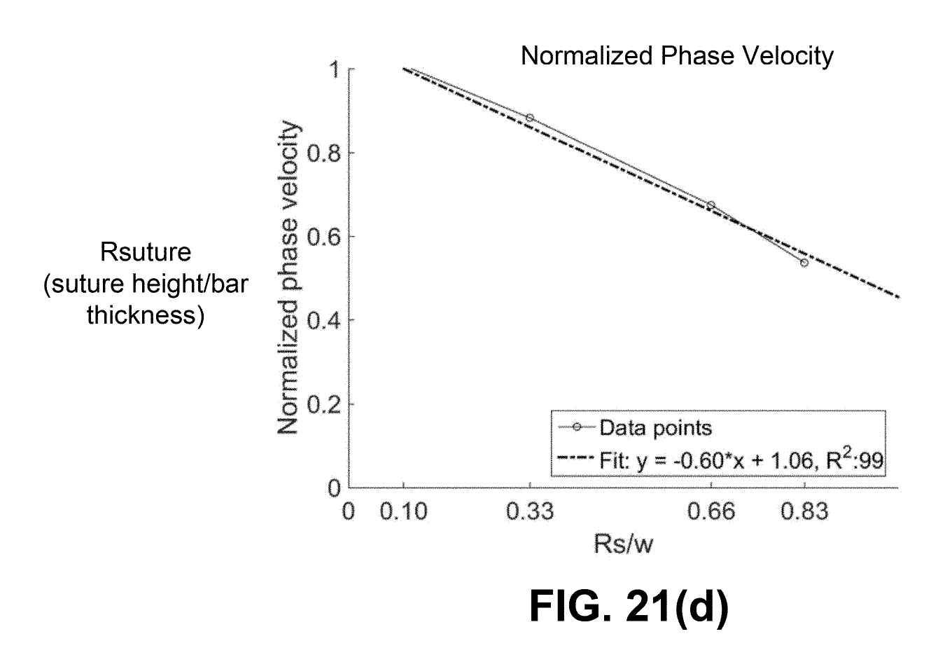

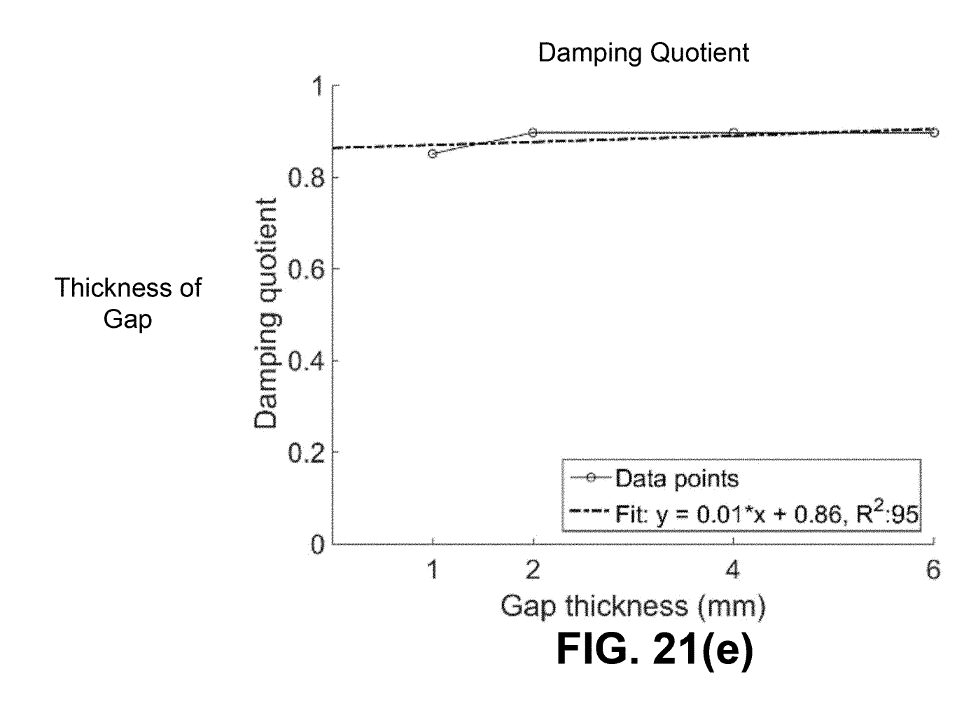

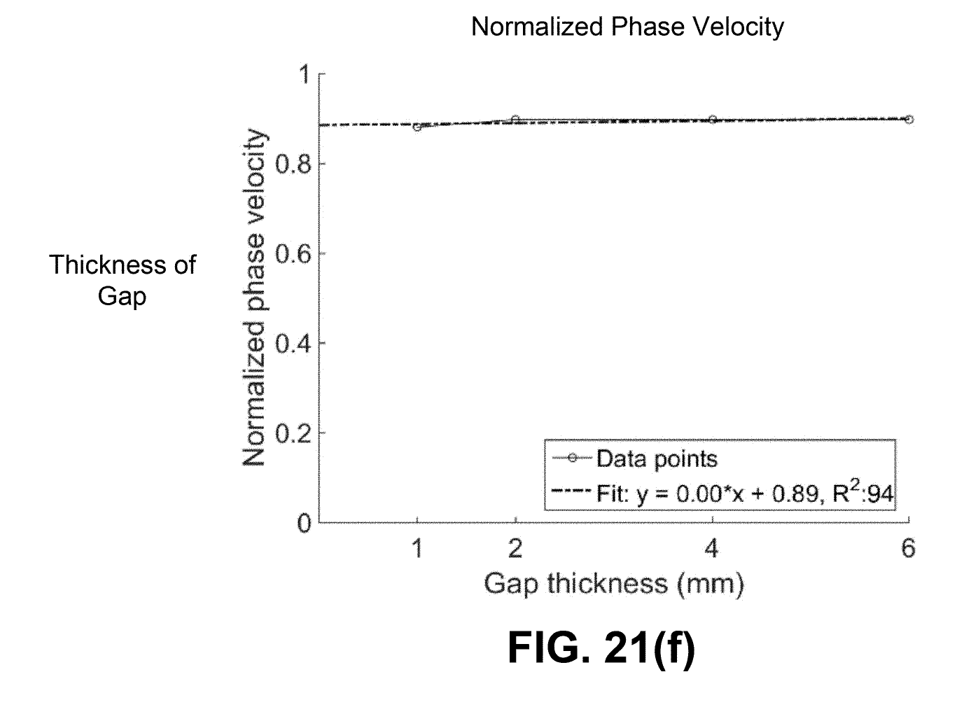

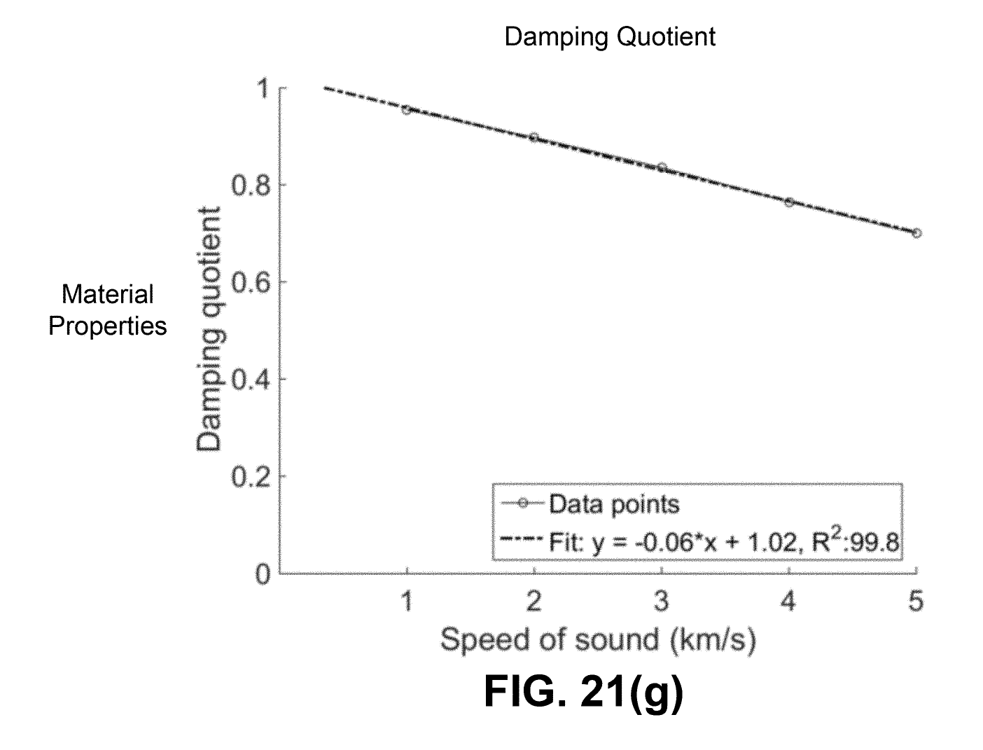

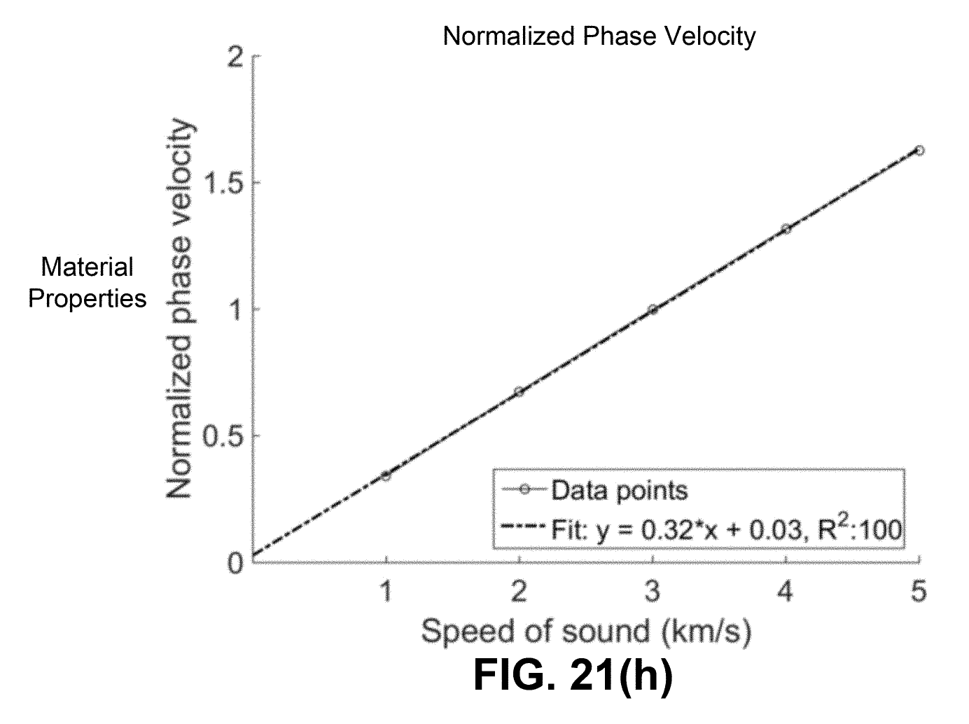

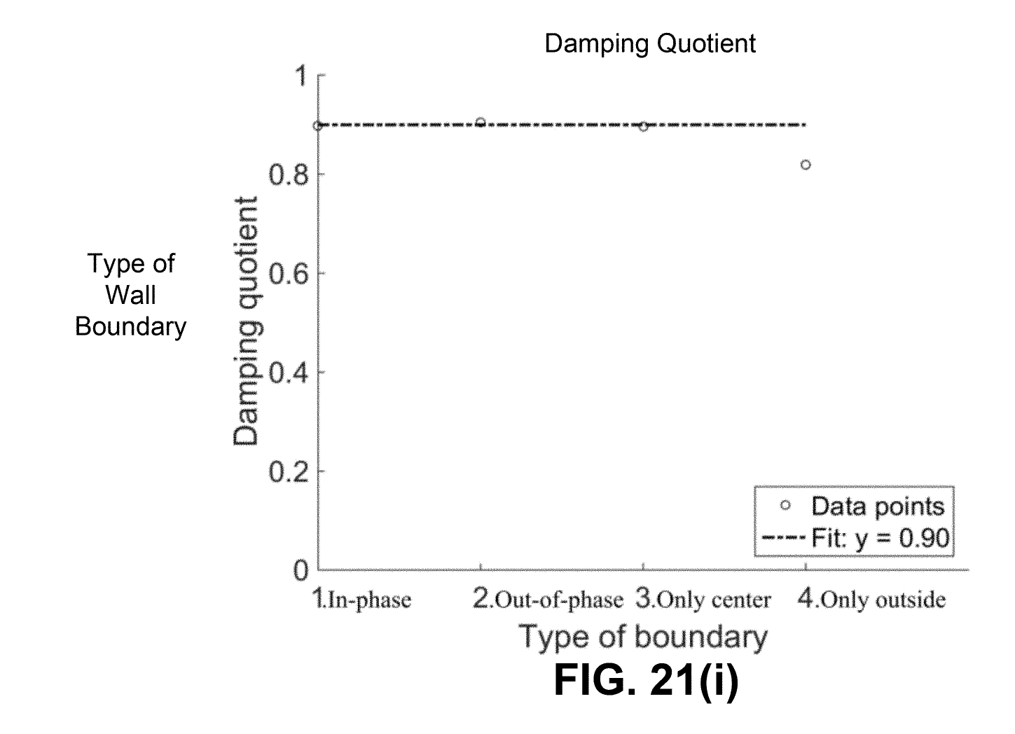

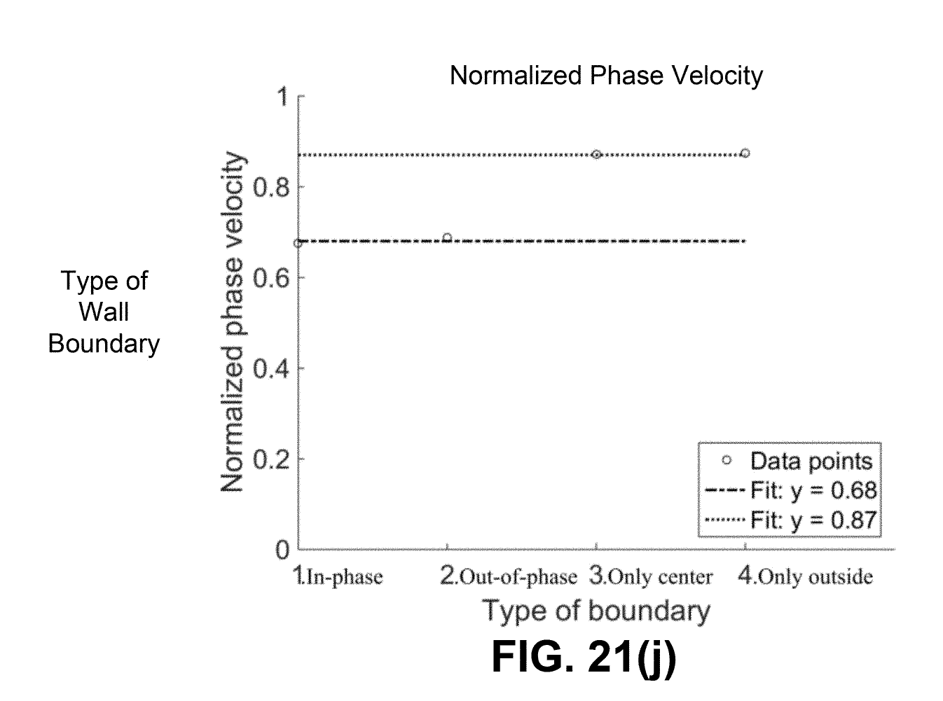

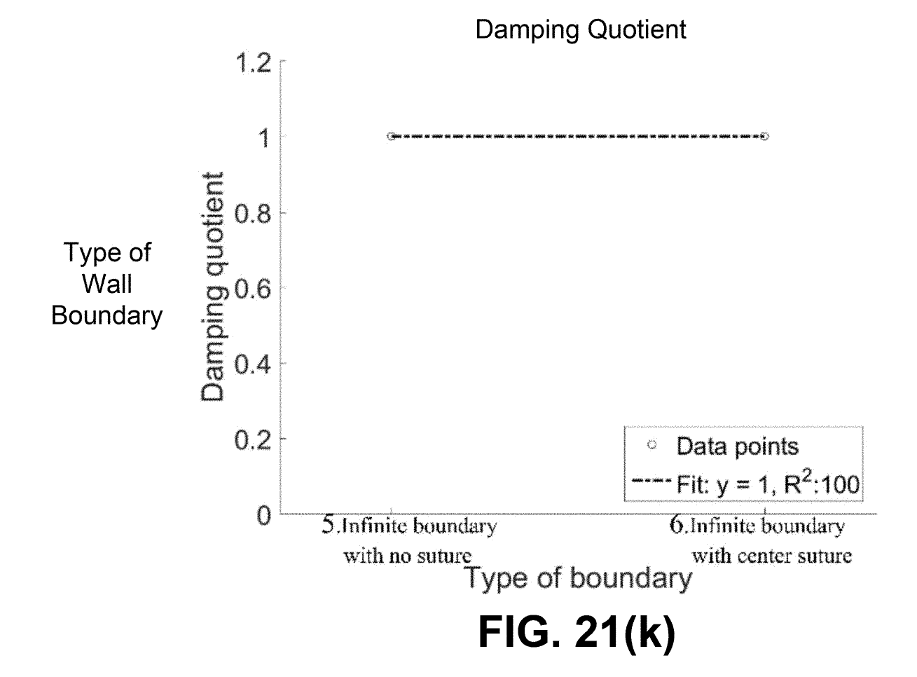

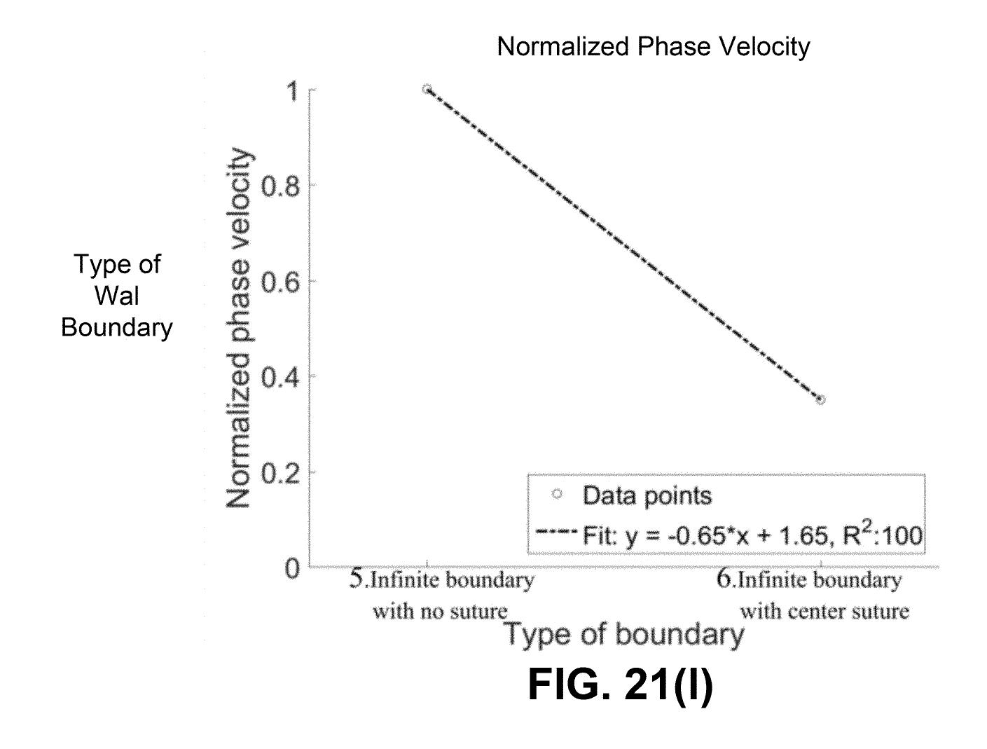

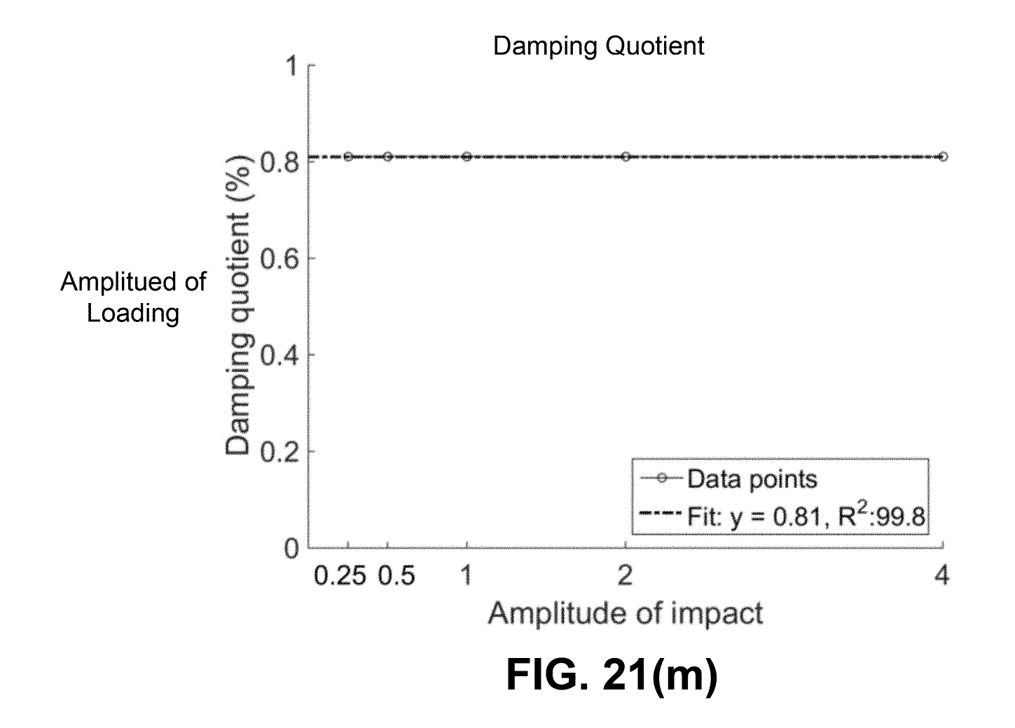

The damping quotient and normalized phase velocity were evaluated to quantify the variables' effects on stress wave mitigation. FIG. 21 shows the correlation of each variable with respect to the attenuation and dispersion of the pressure waves.

FIG. 21(a) and FIG. 21(b) show the relationships between waviness and the damping quotient/phase velocity. Due to the minimal relationship between the suture waviness and damping quotient as evinced by a slope value of 0.04 (R2:45), and between the waviness and phase velocity with a slope value of 0.07 (R2:91), the suture waviness essentially did not affect the damping. Rₛᵤₜᵤᵣₑ versus damping quotient is illustrated in FIG. 21(c) to show that the damping quotient was proportional to the Rₛᵤₜᵤᵣₑ. The damping quotient increased from 0.57 to 0.94 as the Rₛᵤₜᵤᵣₑ increased from 0 to 0.83. Hence, every unit increment increase of Rₛᵤₜᵤᵣₑ gives a 45% increase of damping. Also, the normalized phase velocity proportionally decreased as Rₛᵤₜᵤᵣₑ increased (FIG. 21(d)). Jaslow reported that the amount of energy absorbed may depend on the morphology of the suture (Jaslow, C. R., 1990. Mechanical propertise of cranial sutures. J Biomechanics 23, 313-321), and the study findings related to the present invention indicated that the amount of energy mitigated was directly related to Rₛᵤₜᵤᵣₑ rather than the waviness. FIG. 21(e) and FIG. 21(f) show that the gap thickness did not substantially affect the wave dissipation and dispersion. FIG. 21(g) and FIG. 21(h) show that the sound speed determined by material properties gave changes in damping and phase velocity proportionally but less than the Rₛᵤₜᵤᵣₑ effect. Regarding the type of boundary with finite boundaries, there was no difference in the damping quotient and phase velocity between the in-phase and out-of-phase sutures, while the absence of suture lines led to less attenuation and dispersion as shown in FIG. 21(i) and FIG. 21(j). For the bars with infinite boundaries, the damping quotients were unity in both the sutured and unsutured bars, because all the pressure waves were dissipated before reaching the end (FIG. 21(k)). However, sutures played an important role in dispersing the pressure waves in the bar with infinite boundaries (FIG. 21(l)) as the wave speed velocity was reduced 65%. FIG. 21(m) and FIG. 21(n) show that the impact amplitude did not correlate to the damping quotient and phase velocity. FIG. 21(o) and FIG. 21(p) indicate that the impact duration affected the wave attenuation but not the wave dispersion.

As a result, the three variables including Rₛᵤₜᵤᵣₑ, speed of sound, and impact duration affected the damping quotient, and two variables including Rₛᵤₜᵤᵣₑ and speed of sound affected the normalized phase velocity.

5. Conclusions

One unique characteristic of biological materials is the effective use of elasticity and viscoelasticity for mitigating and dissipating energy. Although shock absorbers such as car bumpers or guard rails are designed to absorb impact energy through plastic deformation, biological materials cannot use this strategy for absorbing energy because severe plastic deformation could cause fatal damage. To keep structural integrity, biological materials use elastic and viscoelastic responses effectively to dampen stress waves and absorb energy. Sutures are found in nature in which energy absorption and stress wave damping are important, and they function in two roles: (i) suture interfaces transform longitudinal waves into shear waves and flexural waves so that elastic deformation arises in not only the longitudinal direction but the transverse and shear directions as well; and (ii) the interaction between viscoelastic material in the gap and suture geometry lead to stress wave damping.

In addition, variations of suture interfaces and boundary conditions were investigated to evaluate their correlation to damping. As a result, there were three variables that increased wave attenuation: (i) high ratio of the suture height to the bar thickness, (ii) a short external impact duration, and (iii) low sound speed dictated by the elastic modulus. The two variables causing wave dispersion were a high ratio of the suture height over the bar thickness and a low sound speed. If the material properties and impact duration cannot be controlled in the engineering design of a structural component or system, making the suture height greater becomes the only controllable design variable that matters.

C. Helmet with Spiral Elements and/or Sutures

The helmet in some embodiments comprises a shell that has a first portion and a second portion. The first portion of the shell may include a core layer that is surrounded by layers that are denser than the core layer. For example, the core layer may be constructed of a foam, and the surrounding layers may be constructed of a para-aramid synthetic fiber, such as a KEVLAR fiber, fixed in a matrix. Because the core layer is less dense than the surrounding layers, the first portion of the shell may mitigate shock waves that are imparted to the helmet.

Furthermore, in some embodiments, a suture or suture(s) (i.e., at least one suture) may be formed in one of the layers that surrounds the core layer. An elastomeric adhesive may be disposed in the suture to hold portions of the layer together. The suture and elastomeric adhesive may also mitigate shock waves that are imparted to the helmet.

In addition, the second portion of the shell may include multiple energy dissipaters, such as elastomeric tapered spirals. The energy dissipaters may be configured to dissipate energy imparted to the helmet. In particular, the energy dissipaters may dissipate energy through shear action in the energy dissipaters.

Various embodiments of the helmets described herein may mitigate shock waves, trap momentum, and dissipate energy so that the risk of wearers experiencing injuries, such as MTBI and CTE, are reduced. In the following discussion, a general description of the system and its components is provided, followed by a discussion of the operation of the same.

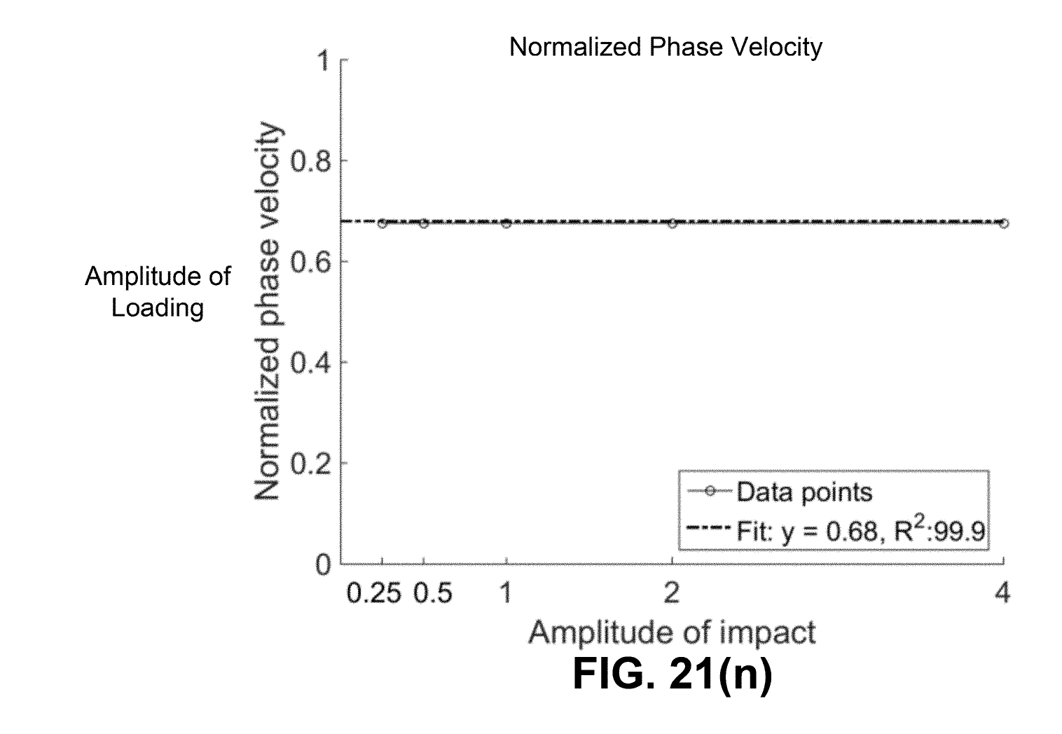

With reference to FIG. 22, shown is a cross-section of an example of a football helmet 100 according to various embodiments. In alternative embodiments, the helmet 100 may be embodied in the form of other types of athletic helmets, such as hockey helmets, lacrosse helmets, etc. Additionally, the helmet 100 in other examples may be embodied in the form of a racing helmet, such as an automotive racing helmet, a motorbike racing helmet, etc. In addition, the helmet 100 in alternative examples may be embodied in the form of a tactical helmet, which may be used, for example, by law enforcement or military personnel.

The helmet 100 may comprise a shell 103, a facemask 106, a liner (not shown), and/or other components. The shell 103 may be the outermost portion of the helmet 100 that surrounds at least a portion of the wear's head. Accordingly, the exterior surface of the shell 103 may contact objects, such as other helmets 100, when in use. The facemask 106 may protect the face of the wearer of the helmet 100.

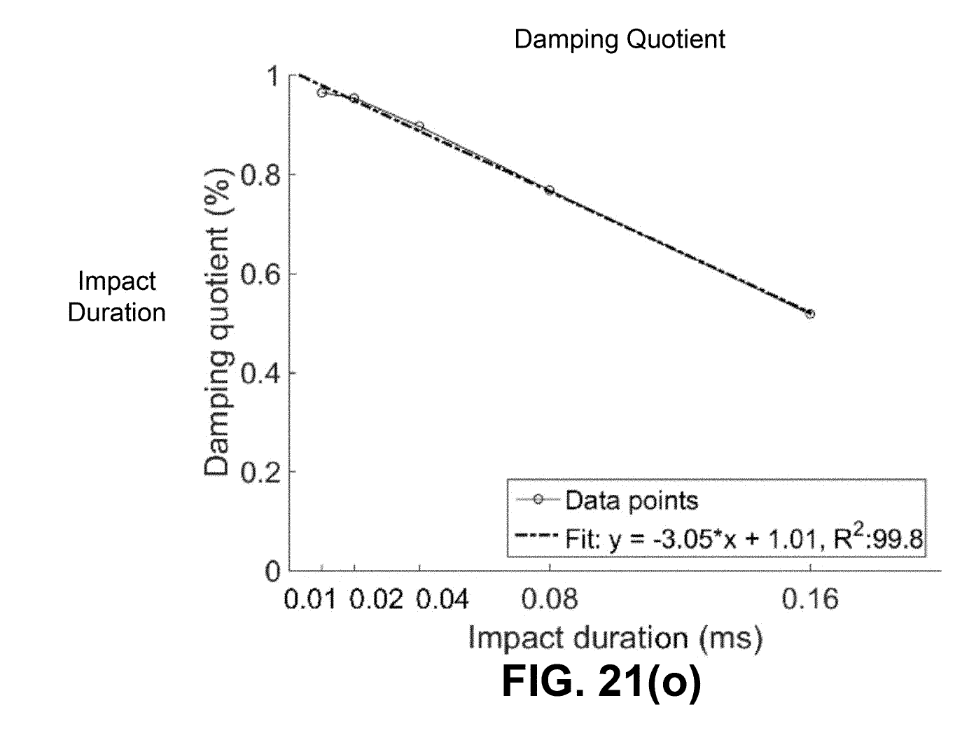

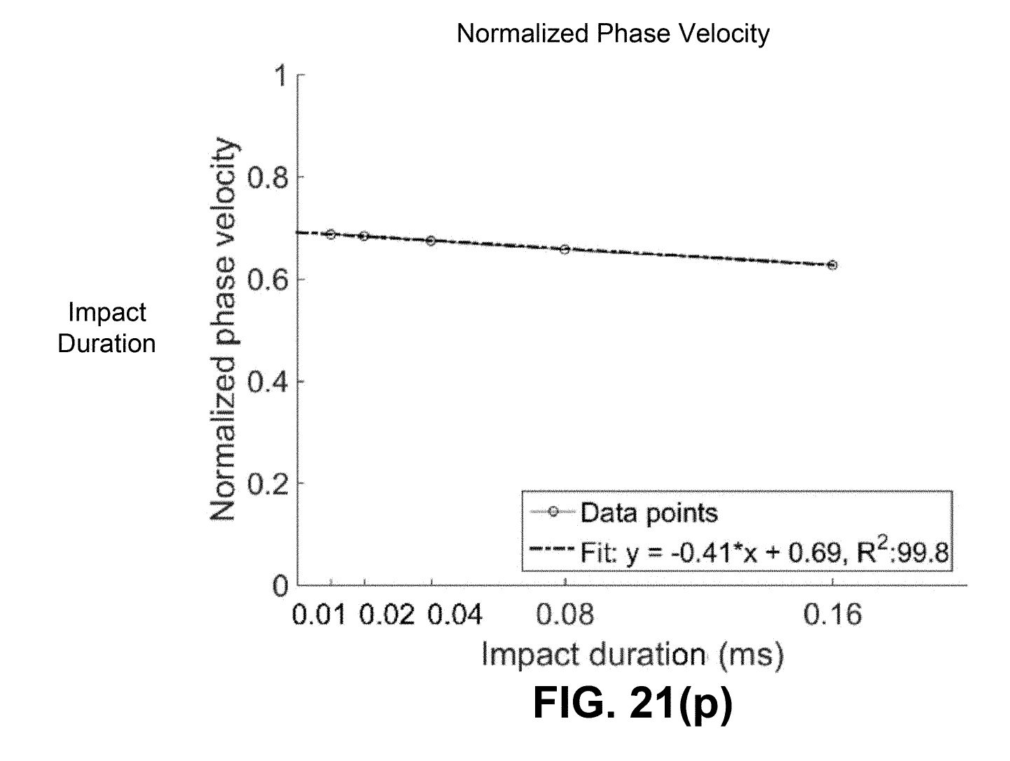

With reference to FIG. 23, shown is a cross-section of a portion of an example of the shell 103 according to various embodiments. The shell 103 illustrated in FIG. 23 is a multilayer shell 103 that comprises a first portion 203 and a second portion 206. For the embodiment shown in FIG. 23, the first portion 203 of the shell 103 is on the exterior side of the shell 103, and the second portion 206 of the shell 103 is on the interior side of the shell 103. However, in alternative embodiments, the first portion 203 of the shell 103 may be on the interior side of the shell 103, and the second portion 206 of the shell 103 may be on the exterior side of the shell 103. Additionally, for the embodiment illustrated in FIG. 23, the first portion 203 of the shell 103 is in direct contact with the second portion 206 of the shell 103. In alternative embodiments, the first portion 203 of the shell 103 may be separated from the second portion 206 of the shell 103.

FIGS. 23(a) and 23(b) show different configurations for the shell. The embodiment illustrated in FIG. 23(a) shows that the first portion 203 of the shell 103 may include a core layer 209 that is positioned between a first surrounding layer 213 and a second surrounding layer 216. The first surrounding layer 213 and the second surrounding layer 216 may comprise a para-aramid synthetic fiber, such as a KEVLAR, carbon, E-glass, or S-Glass fiber, that is fixed in a polymeric matrix. In FIG. 23(b), a layer 214 is added that may be a very hard, slippery layer comprising a thermoset or thermoplastic on the outside of layer 213. Such a matrix for any configuration in FIGS. 23(a) and 23(b) may comprise polypropylene, polyurethane, polycarbonate, and/or any other suitable material. The first surrounding layer 213 and the second surrounding layer 216 may be denser and less porous than the core layer 209. FIG. 23(b) also includes layer 215, which comprises a wavy suture material made of a nonlinear highly deforming elastic material, viscoelastic material, and/or viscoplastic material. Layer 216 comprises a polymeric thermoplastic or thermoset that is highly ductile that can be, but is not limited to, a polycarbonate, sorbothane, etc.

For the configuration illustrated in FIG. 23(a), the core layer 209 may comprise a foam. For example, the core layer 209 in one embodiment comprises a polymeric foam that can be, but is not limited to, a SUNMATE foam (commercially available from Dynamic Systems, Inc., U.S.A. The core layer 209 may be less dense and more porous than both the first surrounding layer 213 and the second surrounding layer 216. Accordingly, the first portion 203 of the shell 103 may be functionally graded. For the configuration illustrated in FIG. 23(b), layer 217 can be a closed or open cell polymeric foam that can be used for energy absorption. This foam material can be, but is not limited to, a SUNMATE foam.

The second portion 206 of the shell 103 may include a side layer 219, a plurality of energy dissipaters 223, and a plurality of support columns 226a-226c. In some embodiments, the side layer 219 may comprise a para-aramid synthetic fiber, such as a KEVLAR, carbon, E-glass, or S-glass fiber, fixed in a matrix, such as a polypropylene, polyurethane, polycarbonate, and/or any other suitable matrix.

The support columns 226a-226c may attach the side layer 219 to the first portion 203 of the shell 103. For the embodiments illustrated in FIGS. 23(a) and 23(b), the support columns 226a-226c attach to both the side layer 219 and the second surrounding layer 213. In addition, the support columns 226a-226c may position the side layer 219 so that the side layer 219 does not contact the energy dissipaters 223. In some embodiments, the support columns 226a-226c comprise a polycarbonate.

The energy dissipaters 223 are configured to dissipate energy that is imparted to the helmet 100. In some embodiments, an energy dissipater 223 may dissipate energy by a shearing action in the energy dissipater 223. Examples of energy dissipaters 223 are described in further detail below. In some embodiments, the energy dissipaters 223 may be arranged in rows throughout at least a portion of the shell 103, as illustrated in FIGS. 23(a) and 23(b).

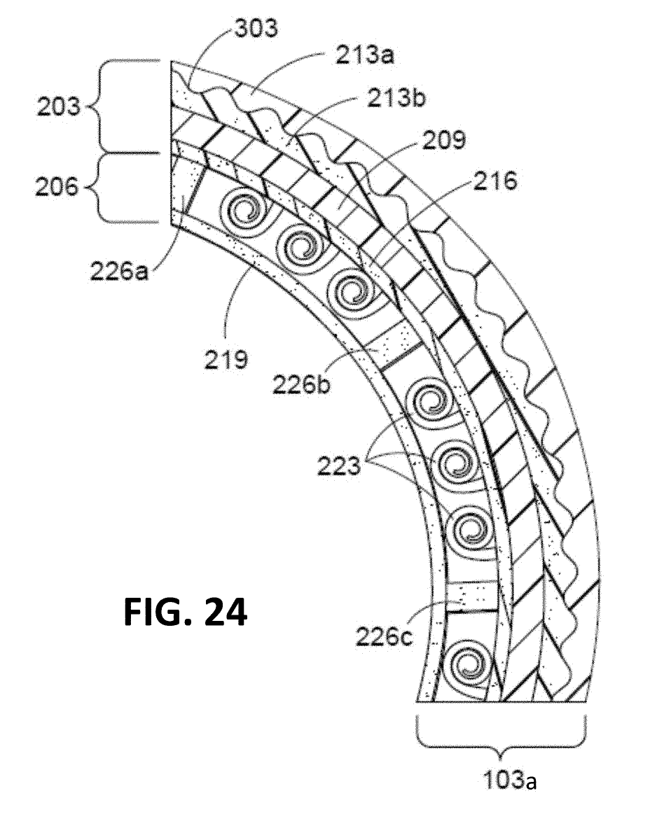

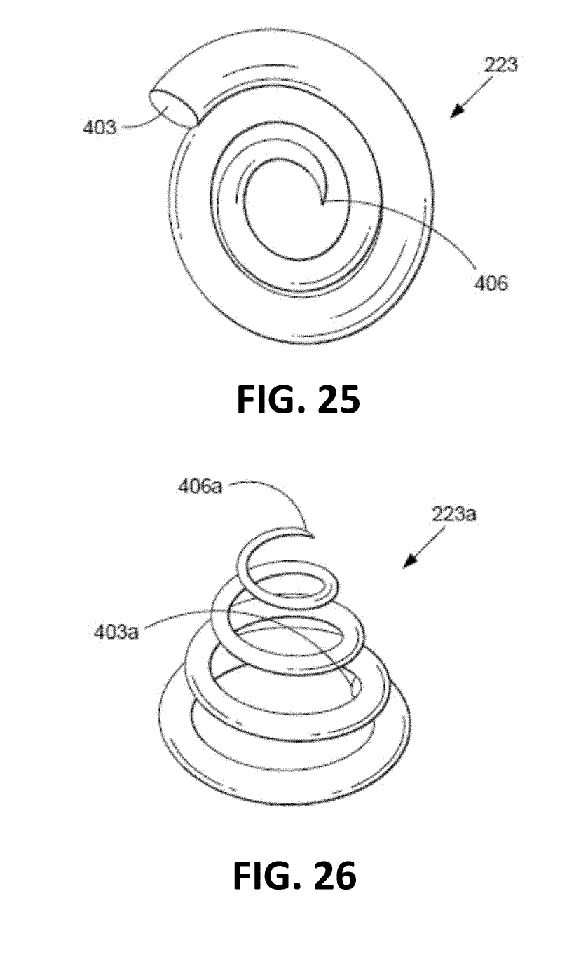

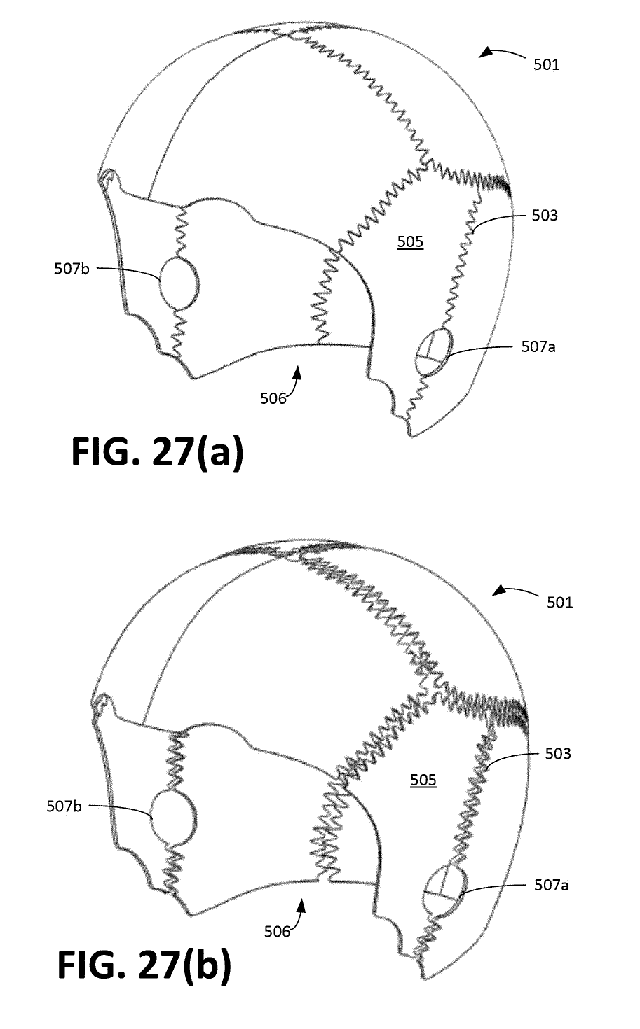

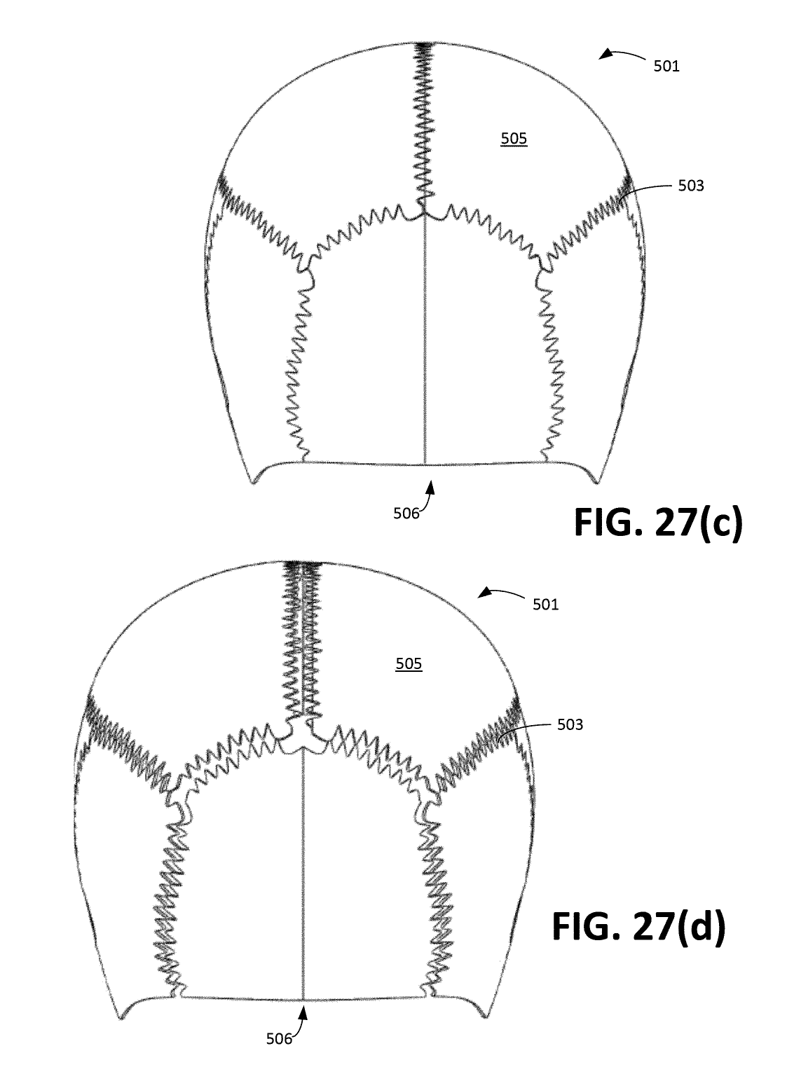

Furthermore, in some embodiments, an impact absorbing article of manufacture can be made with a plurality of layers that exhibit waviness in different directions and/or different planes (perpendicular or transverse) to more effectively dissipate impact energy by converting same into shear waves when the article is impacted. As an example, the embodiment of FIG. 23(b) can be used in combination with the embodiment of FIGS. 27(a) through 27(d). With reference to FIG. 23(b), note that the edges of the suture junction 218 between the first material layer 215 and the second material layer 216 exhibit a waviness that is in a direction that is different than the waviness of the suture edges shown in FIGS. 27(a) through 27(d). The waviness of the edges of the suture junction 218 of FIG. 23(b) is generally in a plane (in this case, a curved plane) that is orthogonal, or perpendicular, to a plane (in this case, a curved plane) associated with the waviness of the suture edges of FIGS. 27(a) through 27(d). In some embodiments, the relationship could be transverse as well. This feature results in better dissipation of impact energy and action.

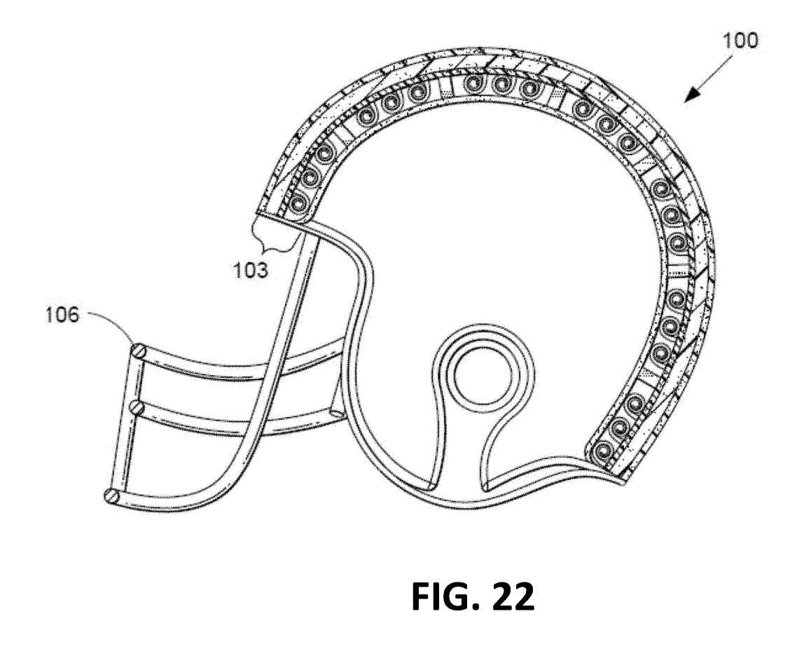

With reference to FIG. 24, shown is a cross-section of a portion of another example of the shell 103, referred to herein as the shell 103a, according to various embodiments. The shell 103a has some features that are similar to the shell 103 illustrated in FIG. 23. However, the first surrounding layer 213 of the first portion 203 of the shell 103 is segmented into a first surrounding layer portion 213a and a second surrounding layer portion 213b.

In particular, a suture 303 may exist between the first surrounding layer portion 213a and the second surrounding layer portion 213b. The suture 303 may be regarded as being a relatively rigid joint between the first surrounding layer portion 213a and the second surrounding layer portion 213b. In some embodiments, the suture 303 may extend around the entire shell 103. In other embodiments, the suture 303 may extend around only a portion of the shell 103. The suture 303 may comprise an elastomeric adhesive. In addition to attaching the first surrounding layer portion 213a to the second surrounding layer portion 213b, the elastomeric adhesive may facilitate shear deformation in the first surrounding layer 213 when the helmet 100 is subjected to an impact.

The suture 303 may have a sinusoidal shape that is curved to conform to the shape of the shell 103. In these embodiments, the ratio of the amplitude to the wavelength may be within the range from about 0.25 to about 2.0.

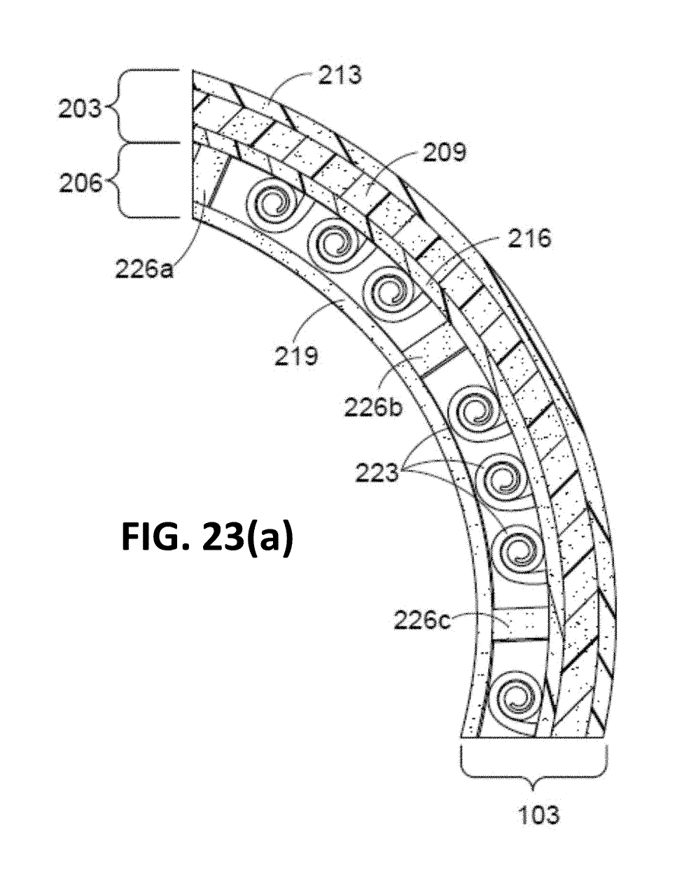

With reference to FIG. 25, shown is an example of a tapered spiral shaped element 223. The spiral shaped element 223 is in a planar configuration, i.e., a spiral in a single plane. The spiral shaped element 223 illustrated in FIG. 25 comprises a tapered spiral structure. In particular, the spiral shaped element 223 shown comprises a base 403 and a tip 406 that has a diameter less than the diameter of the tip 406. In some embodiments, the ratio of the diameter of the tip 406 to the diameter of the base 403 may be within the range from about 0.1 to about 0.9. Additionally, the ratio of the diameter of the base 403 to the spiral length may be from about 0.01 to about 1.0.

The base 403 of the spiral shaped element 223 may be attached directly to the second surrounding layer 216 of the first portion 203 of the shell 103. When the helmet 100 is subjected to an impact, energy may be transferred to the spiral shaped element 223 and dissipated through shear action in the spiral shaped element 223.

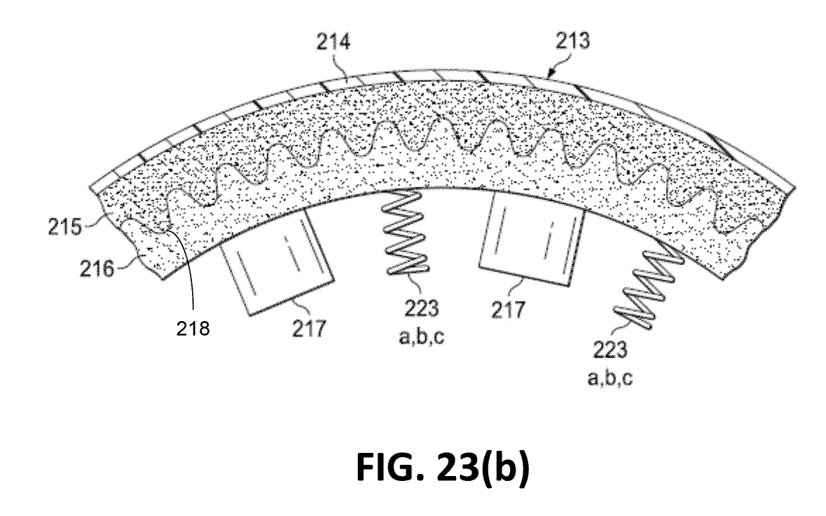

With reference to FIG. 26, shown is another example of a spiral shaped element 223, referred to herein as the spiral shaped element 223a. The spiral shaped element 223a is a tapered conic helix structure. In this regard, the spiral shaped element 223a forms a conic helix, and the diameter of the spiral shaped element 223a tapers as the length progresses from the base 403a to the tip 406a.

The base 403a of the spiral shaped element 223a may be attached directly to the second surrounding layer 216 of the first portion 203 of the shell 103. When the helmet 100 is subjected to an impact, impact energy is transferred to the spiral shaped element 223a and dissipated through shear action in the spiral shaped element 223a.

FIGS. 27(a) through 27(d) are views of an embodiment of a material layer 501 for a helmet wherein the material layer 501 has a plurality of suture junctions 503, denoted by reference numeral 503. The material layer 501 has an opening 506 with sufficient size and shape to receive the head of a human and includes ear holes 507a and 507b. In this example, the material layer 501 has 8 sections 505 that are separated by the suture junctions 503. The suture junctions 503 comprise wavy interfaces between different sections of the material layer 501 or a wavy gap with or without a material within the gap. Each suture junction 503 has edges associated respectively with adjacent sections. The edges are movable relative to each other so that the edges are capable of transforming a substantial part of a longitudinal mechanical shock wave imposed upon edges into shear waves within the material layer when an article having the material layer is impacted by an object in order to dissipate the impact energy and action.

D. Variations, Modifications, and Other Embodiments

It should be emphasized that the above-described embodiments of the present invention, particularly any “preferred” embodiments, are merely possible examples of implementations that are set forth for a clear understanding of the principles of the invention. Many variations and modifications may be made to the above-described embodiment(s) of the invention without departing substantially from the spirit and principles of the invention. All such modifications and variations are intended to be included herein within the scope of the disclosure of the present invention. References to ‘a’ or ‘an’ concerning any particular item, component, material, structure, or product is defined as at least one and could be more than one.

The spiral shaped elements in the shock mitigating material can take many different shapes and sizes, depending upon design and/or manufacturing preferences. Also, the suture can also take different wave forms (sinusoid, blocks, triangles, etc.) with different amplitudes and periods.

In some embodiments of shock mitigating materials, each spiral shaped element has a consistently shaped cross section (e.g., circular, polygonal, triangular, square, rectangular, trapezoidal, etc.) throughout its length and is tapered either from a large outside end to a small inside end or from a small outside end to a large inside end. The amplitude and the period of the embedded wavy material may also change within the structure.

In other embodiments of shock mitigating materials, each of the spiral shaped elements is configured in the shape of a helix (or corkscrew). Moreover, the helix in this configuration may be tapered or non-tapered. Finally, each element can be in the shape of a conical helix, conical toroid, cylinder helix, or other helix. The suture may also have three dimensional helical attributes as well.

In other embodiments of shock mitigating materials, each of the spiral shaped elements reside (are coiled) in a single plane. The elements can be placed side by side in the materials.

In other embodiments of shock mitigating materials, each of the spiral shaped elements is a sheet that is disposed in a rolled configuration so that its cross section along the span of the elongate structure is spiral. The sheet can be tapered or non-tapered from an outside end to an inside end. Furthermore, each of the elements can be non-uniform along the elongated span of the rolled configuration; for example, it could be conical.

In other embodiments of shock mitigating materials, there exists a mix of different types of spiral shaped elements, as previously mentioned.

At least the following is claimed:

1. An article of manufacture having a manufactured, shock mitigating, material layer designed to dissipate impact energy when the article is physically impacted by an object, the material layer comprising:
first and second sections, each of the first and second sections having a top surface, a bottom surface, and a periphery of edges;
a suture junction where the first and second sections meet, the junction comprising first and second edges associated respectively with the first and second sections, the first and second edges of the junction generally exhibiting parallel waveforms; and
wherein each of the first and second edges are movable relative to each other so that the first and second edges are capable of transforming a substantial part of a longitudinal mechanical shock wave imposed upon the first and second edges into shear waves within the material layer when the article is impacted by the object in order to dissipate the impact energy and action.

2. The article of manufacture of claim 1, wherein the material layer is a first material layer and further comprising a second material layer, the second material layer comprising:
first and second sections, each of the first and second sections having a top surface, a bottom surface, and a periphery of edges;
a suture junction where the first and second sections meet, the junction comprising first and second edges associated respectively with the first and second sections, the first and second edges of the junction generally exhibiting parallel waveforms;
wherein each of the first and second edges are movable relative to each other so that the first and second edges are capable of transforming a substantial part of a longitudinal mechanical shock wave imposed upon the first and second edges into shear waves within the second material layer when the article is impacted by the object in order to dissipate the impact energy and action; and
wherein the waviness associated with the parallel waveforms of the second material layer are in a plane that is orthogonal to the waviness associated with the parallel waveforms of the first material layer.

3. The article of manufacture of claim 1, wherein the first and second edges are contiguous at the junction.

4. The article of manufacture of claim 1, wherein each of the first and second sections are made of a material selected from the group consisting of nylon, polycarbonate, polypropylene, and polymer.

5. The article of manufacture of claim 1, further comprising a third section of a material at the junction, the third section being between the first and second edges of the first and second sections.

6. The article of manufacture of claim 4, wherein the first, second, and third sections are made from the same material.

7. The article of manufacture of claim 4, wherein the third material is made of a material selected from the group consisting of a polymer and a rubber.

8. The article of manufacture of claim 4, wherein the first and second sections are made from a first material and the third section is made from a second material that is different than the first material.

9. The article of manufacture of claim 1, wherein the first and second edges are separated by a gap of air at the junction.

10. The article of manufacture of claim 1, wherein the first and second edges exhibit a sinusoidal shape.

11. The article of manufacture of claim 1, wherein the first and second edges exhibit a saw tooth shape.

12. The article of manufacture of claim 1, wherein the waveforms are non-periodic.

13. The article of manufacture of claim 1, wherein the waveforms are periodic.

14. An article of manufacture having a manufactured, shock mitigating, material layer designed to dissipate impact energy when the article is physically impacted by an object, the material layer comprising:
first and second sections, each of the first and second sections having a top surface, a bottom surface, and a periphery of edges;
first and second edges associated respectively with the first and second sections, the first and second edges exhibiting substantially parallel waveforms; and
wherein each of the first and second edges are movable relative to each other so that the first and second edges are capable of transforming a substantial part of a longitudinal mechanical shock wave imposed upon the first and second edges into shear waves within the material layer when the material layer is impacted by the object in order to dissipate the impact energy and action.

15. The article of manufacture of claim 14, wherein the first and second edges are contiguous.

16. The article of manufacture of claim 14, further comprising a third section of a material situated between and contiguous with the first and second edges of the first and second sections, the third section exhibiting wavy sides.

17. The article of manufacture of claim 14, wherein the first and second edges are separated by a gap of air.

18. The article of manufacture of claim 14, further comprising a second material layer that exhibits a waviness in a direction that is different than that of the material layer.

19. The article of manufacture of claim 14, wherein the waveforms are non-periodic.

20. An article of manufacture having a manufactured, shock mitigating, material layer designed to dissipate impact energy when the article is physically impacted by an object, the material layer comprising:
first and second sections, each of the first and second sections having a top surface, a bottom surface, and a periphery of edges;
first and second edges associated respectively with the first and second sections;
a third section situated between and contiguous with the first and second edges of the first and second sections, the third section exhibiting a wavy configuration;
wherein each of the first and second edges are movable relative to each other so that the first and second edges are capable of transforming a substantial part of a longitudinal mechanical shock wave imposed upon the first and second edges into shear waves within the material layer when the material layer is impacted by the object in order to dissipate the impact energy and action;
wherein the first section is made of a material selected from the group consisting of nylon, polycarbonate, polypropylene, and polymer;
wherein the second section is made of a material selected from the group consisting of nylon, polycarbonate, polypropylene, and polymer; and
wherein the third section is made of a material selected from the group consisting of a polymer and a rubber.
